(19) United States
(12) Patent Application Publication
(10) Pub. No.: US 2014/0279078 A1
(43) Pub. Date: Sep. 18, 2014

(54) Enriching An Advertiser's Product-Related Information

(71) Applicant: Adchemy, Inc., Foster City, CA (US)

(72) Inventors: Murthy V. Nukala, San Mateo, CA (US); Ethan James Batraski, San Francisco, CA (US); Alessandro Magnani, Menlo Park, CA (US); Srinidhi Ramesh Kondaji, Mountain View, CA (US); Richard Edwin Chatwin, Los Altos Hills, CA (US); Siva Kumar Gorantla, San Carlos, CA (US); Scott Harold Fish, San Carlos, CA (US); Zuzar F. Nafar, Mountain View, CA (US); Gopalakrishnan Krishnan, San Jose, CA (US); Dmitry Serenbrennikov, East Palo Alto, CA (US); Seán Padraig Lightholder, Fremont, CA (US)

(73) Assignee: Adchemy, Inc., Foster City, CA (US)

(21) Appl. No.: 14/217,156

(22) Filed: Mar. 17, 2014

Related U.S. Application Data
(60) Provisional application No. 61/800,641, filed on Mar. 15, 2013.
(60) Provisional application No. 61/794,925, filed on Mar. 15, 2013.

(51) Int. Cl. G06Q 30/02

(52) U.S. Cl. CPC G06Q 30/0277
USPC 705/14.73

(57) ABSTRACT

In one embodiment, a method includes accessing information about an advertiser's product catalog. The method may further include accessing an information graph that contains nodes and edges connecting the nodes. The nodes in the graph represent concepts related to at least one vertical. The method further includes associating a first node in the graph with a second node in the graph based on a relationship between the meaning of the concept represented by the first node and the meaning of the concept represented by the second node. A portion of the graph corresponds to the advertiser's product catalog. The method may further include enriching information associated with the portion of the product catalog with information related to the concepts and relationships represented by the portion of the graph corresponding to the portion of the product catalog of the advertiser.

### RELATED APPLICATION(S)

This application claims the benefit, under 35 U.S.C. §119(e), of U.S. Provisional Patent Application No. 61/800,641, filed 15 Mar. 2013, which is incorporated herein by reference. This application also claims the benefit, under 35 U.S.C. §119(e), of U.S. Provisional Patent Application No. 61/794,925, filed 15 Mar. 2013, which is incorporated herein by reference.

### TECHNICAL FIELD

This disclosure generally relates to characterizing electronic content and interactions with that content, and to advertising based on those characterizations.

### BACKGROUND

Advertising is frequently performed on an electronic medium, such as the internet. An advantage of internet advertising over more traditional advertising (such as advertising on billboards or in newspapers or magazines) is more customized or personal advertising, even down to the level of individual users. More personalized advertising tends to be more effective than less personalized advertising, and personalized advertising tends to be more effective when the advertisements are specifically directed at users who are more likely to be interested in the advertisements. Such users are less likely to discard or ignore the advertisements, and as a result the advertisements are more likely to generate revenue. At the same time, more personalized advertising typically reduces advertising costs for advertisers, as the advertisements are usually delivered to fewer users.

Advertisements are commonly used on the internet to promote various products (such as, for example, physical products, software products, or services). Advertisements may include, for example, banner advertisements, links to webpages, images, video, text, etc. The various advertisements used to promote products on the internet may be displayed according to a variety of formats, such as, for example, in conjunction with a ranked result set in response to a search engine query. The advertisements displayed to a user may be selected, redirecting the user to a website providing the product or service advertised.

### BRIEF DESCRIPTION OF THE DRAWINGS

FIG. 1 illustrates an example system comprising parties involved in digital-marketing campaigns and the relationships between the parties.

FIG. 2 illustrates an example information graph.

FIG. 3 illustrates an example knowledge base represented as an example information graph.

FIG. 4 illustrates an example enriched travel graph.

FIG. 5 illustrates an example method for gathering data and building, updating, and generating an information graph.

FIG. 6 illustrates an example method for managing targeted advertising strategies in connection with an example enriched graph.

FIG. 7 illustrates an example advertisement optimizer and with example inputs and outputs.

FIGS. 8A-B illustrate example user interfaces for selecting example products, attributes, and related information to include in a targeted advertising campaign.

FIGS. 9A-B illustrate example user interfaces for creating example ad copy.

FIGS. 10A-B illustrate example advertising performance reports.

FIGS. 11A-B and 12 illustrate example user interfaces for selecting example products from an example catalog to target to consumers.

FIGS. 13A-C illustrate example user interfaces for creating example ad copy and advertising campaigns.

FIG. 14 illustrates an example advertising platform in an example network environment.

FIG. 15 illustrates an example computer system.

### DESCRIPTION OF EXAMPLE EMBODIMENTS

FIG. 1 illustrates an example system 100 comprising parties involved in digital-marketing campaigns and the relationships between the parties. System 100 may include one or more ad exchanges 110, one or more publishers 120, one or more visitors 130, one or more brokers 140, and one or more advertisers 150. Each ad exchange 110 may service one or more publishers 120, one or more brokers 140, or one or more advertisers 150. Each publisher 120 may have one or more available ad inventories 122 at any given time, and each ad inventory 122 may include an ad space 124 for placing an advertisement and a visitor 130 to whom the advertisement is to be presented. Each broker 140 may represent one or more advertisers 150 and manage digital-marketing campaigns for these advertisers 150. Each advertiser 150 may have one or more advertisements 152 and one or more landing pages 154 to be presented to the various visitors 130. A publisher 120 may interact with brokers 140 or advertisers 150 directly or may employ an ad exchange 110 to interact with brokers 140 or advertisers 150. Although FIG. 1 illustrates a particular arrangement of ad exchanges 110, publishers 120, ad inventories 122, ad spaces 124, visitors 130, brokers 140, advertisers 150, advertisements 152, and landing pages 154, this disclosure contemplates any suitable arrangement of ad exchanges 110, publishers 120, ad inventories 122, ad spaces 124, visitors 130, brokers 140, advertisers 150, advertisements 152, and landing pages 154. As an example and not by way of limitation, two or more of ad exchange 110, publisher 120, visitor 130, broker 140, or advertisers 150 may be connected to each other directly, bypassing other parties. As another example, two or more of ad exchange 110, publisher 120, ad inventory 122, ad space 124, visitor 130, broker 140, advertiser 150, advertisement 152, or landing page 154 may be physically or logically co-located with each other in whole or in part. Moreover, although FIG. 1 illustrates a particular number of ad exchanges 110, publishers 120, ad inventories 122, ad spaces 124, visitors 130, brokers 140, advertisers 150, advertisements 152, and landing pages 154, this disclosure contemplates any suitable number of ad exchanges 110, publishers 120, ad inventories 122, ad spaces 124, visitors 130, brokers 140, advertisers 150, advertisements 152, and landing pages 154.

In particular embodiments, ad exchange 110, publisher 120, visitor 130, broker 140, or advertiser 150 may be a network-addressable computing system. Ad exchange 110, publisher 120, visitor 130, broker 140, or advertiser 150 may generate, store, receive, and transmit data, such as, for example, user information, browsing history, website structure and hierarchy, search queries, search results, webpages, the relative location of a webpage or user interfaces “UIs” in a hierarchy of webpages or UIs, advertisements, or other suitable data. Ad exchange 110, publisher 120, visitor 130, broker 140, or advertiser 150 may be accessed by the other components illustrated in FIG. 1 either directly or via a suitable network. In particular embodiments, a visitor 130 may be any suitable client system, which may access ad exchange 110, publisher 120, ad inventory 122, ad space 124, broker 140, advertiser 150, advertisement 152, or landing page 154 directly, via a suitable network, or via a third-party system. A visitor 130 may be a user accessing another component of system 100 via a suitable computing device, such as, for example, a personal computer, a laptop, a cellular phone, a smart phone, or a computing tablet.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Connections may connect ad exchanges 110, publishers 120, visitors 130, brokers 140, or advertisers 150 to a network or to each other. This disclosure contemplates any suitable connections. In particular embodiments, one or more connections include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, each of the one or more connections may include an ad hoc network, an intranet, an extranet, a VPN, a LAN, a WLAN, a WAN, a WWAN, a MAN, a portion of the Internet, a portion of the PSTN, a cellular telephone network, another connection, or a combination of two or more such connections. Connections need not necessarily be the same throughout the system. One or more first connections may differ in one or more respects from one or more second connections.

Typically, an advertiser wishes to sell one or more particular products. As used herein, the term “product” may refer to a physical product, a software product, a service, an intangible product (such as, for example, intellectual property), any suitable good or service, or any suitable combination thereof. To sell products, the advertiser may conduct an advertising campaign to present various advertisements relating to the services or products. Consumers are people or entities to whom the advertisements may be presented. They are the potential customers of the advertisers or the potential buyers of the services or products. An advertiser may target an advertising campaign to consumers in general, to specific groups of consumers, or to individual consumers. Generally, the desired outcome of an advertising campaign is for many consumers to purchase the services or products that the advertiser wishes to sell. There may be multiple parties involved in an advertising campaign. An advertiser or its agent may be considered the sponsor of the advertising campaign.

Advertisements are placed in advertising spaces (or ad spaces) so that they may be presented to the consumers. In the case of digital marketing, the ad spaces exist in electronic media, such as the Internet, software applications, billboards, video games, etc. For example, portions of webpages may be used to present advertisements to people viewing the webpages and these portions of the webpages may be considered ad spaces. Sometimes, an advertiser may have its own ad spaces. In other embodiments, an advertiser may purchase ad spaces from publishers for placing their advertisements. A publisher is a party that owns and sells ad spaces to advertisers and presents the advertisements placed in its ad spaces to visitors on behalf of the advertisers.

A publisher may own any number of advertising inventories at any given time. In particular embodiments, an advertising inventory (or ad inventory) may include a particular ad space that is currently available for placing an advertisement to be presented to a particular visitor. In particular embodiments, an ad inventory may also include information concerning the ad space and information concerning the visitor or generated by the visitor to whom the advertisement is to be presented. Such information may describe characteristics of the ad space, the visitor, or both. Information concerning the ad space, the visitor, or generated by the visitor may be referred to as user information.

An advertising platform may be operated by a publisher, an ad exchange, a broker, an advertiser, or another suitable party. In particular embodiments, an advertiser (i.e., a digital marketer) may have one or more advertising orders (ad order). An ad order represents an order for placing an advertisement in one or more ad spaces to be presented to one or more visitors. In particular embodiments, an ad order may contain the advertisement to be presented to a visitor and one or more desired features of the ad spaces in which to place the advertisement or one or more desired features of the visitors to whom the advertisement is to be presented. In addition, in particular embodiments, an ad order may also include a default bid price that may be used to bid on the ad inventories for placing the advertisement of the ad order in the ad spaces of the ad inventories. In particular embodiments, there may be one or more keywords describing the advertisement (e.g., keywords describing the category or content of the advertisement or keywords describing the service or product being advertised) of the ad order.

In particular embodiments, an advertiser or broker acting on behalf of the advertiser may provide a publisher or ad exchange with a product catalog, which may be referred to as a “product feed” or “merchant feed,” where appropriate. The publisher or ad exchange may match ad spaces to products in the advertiser's product catalog based on features of the ad space, features of the visitor, features of the products as described by the product catalog, or any suitable combination thereof. If the publisher determines a match between the ad space and an advertiser's product, the publisher may construct an ad and/or display an ad in the ad space based on the product information provided in the product catalog. For example, the constructed ad may include an image of the product, the title of the product, a price for the product, or any other suitable information contained in the product catalog.

Each product entry in a product catalog provided to a publisher may include some or all of the following information: ID (Merchant/Product ID); Title (Product Name); Product URL; Price (Price, Sale Price, Shipping, Tax, etc.); Description; Image URL; Brand; GTIN (UPC, EAC, ISBN), the global trade item number of the item; MPN, the manufacturer part number of the item, or any other suitable information identifying or describing a product. In addition or the alternative, a product entry may include information regarding product attributes and/or information regarding the target consumer such as gender or age group. For example, a product entry for a product in an “apparel” category may include information about the availability of the product in various colors, sizes, materials, or patterns, and relevant information about the target consumer such as whether the product is a men's, women's, or child's article of clothing.

An advertiser may have specific criteria associated with an advertising campaign. The criteria may be reflected in the desired ad-space features and desired visitor features specified for the ad orders so that each ad order may target specific time, locations, consumers/users, etc. The desired features may be general or specific. As an example and not by way of limitation, the desired visitor features may include demographical information concerning the visitors, visitors having particular behavioral patterns, etc. The desired ad-space features may include where and when the ad space is presented, who owns the ad space, what event causes the ad space to become available, etc. If an advertiser is advertising about women's clothing, the advertiser may wish to target only female visitors in its advertising campaign. In this case, an ad order may specify <gender=female> as one of its desired visitor features. If the advertiser is a regional business located in Northern California, the advertiser may wish to show its advertisements only to people in California. In this case, the ad order may further specify <location=California> as another one of its desired visitor features. If the advertiser wishes to place its advertisements with a specific publisher (e.g., Google, Yahoo!, etc.) only, the ad order may specify <publisher=Google> as one of its desired ad-space features. If the advertiser wishes to place its advertisements in webpages corresponding to a specific search query (e.g., webpage containing the search result identified for a specific search query) only, the ad order may specify the search query as another one of its desired ad-space features (e.g., ad space contained in webpages corresponding to the search query). If the advertiser wishes to present its advertisements during a particular time period (e.g., on the weekends) only, the ad order may specify “presented on Saturdays and Sundays” as another one of its desired ad-space features. Although this disclosure describes particular features describing ad spaces and visitors, this disclosure contemplates any suitable features describing ad spaces or visitors.

In addition, the advertisement in the ad order often has an associated landing page, which may also be included in the ad order. A landing page is a webpage that is presented to a visitor when the visitor clicks on the associated advertisement. The landing page usually contains content that is a logical extension of the associated advertisement. For example, if the advertisement is about a television, the associated landing page may contain a detailed description or specification of the television, various images of the television, user reviews of the television, unit price, shipping cost, or applicable tax for purchasing the television. The visitor may obtain further information and purchase the television via the landing page. In another example, if the advertisement is about college education, the landing page may contain a form having various informational fields through which the visitor may submit personal information (i.e., user information). The visitor may indicate the degree program and the school in which he is interested, his current education level and profession, his education goal, his age and gender, his annual income, and so on. The visitor may also indicate the specific additional information he is seeking, whether he wishes to be contacted by any specific schools and how, and so on. The visitor may submit the form (e.g., by clicking a “submit” button contained in the landing page) to transmit the information provided in the form to the appropriate party (e.g., the advertiser or the advertising platform). The visitor may then be directed to a confirmation page that contains a tracking pixel, which transmits back to a publisher or ad exchange that the submit has occurred. The submitted information can then be used for pricing, such as, for example, if the ad is sold on a cost-per-action basis, or simply for tracking, reporting, or analytics purposes.

In particular embodiments, an advertiser may submit its ad orders to one or more publishers or one or more ad exchanges. Alternatively, a broker representing an advertiser may submit the ad orders of the advertiser to one or more publishers or one or more ad exchanges on behalf of the advertiser. Multiple advertisers or brokers may submit multiple ad orders to the same publisher or the ad exchange. The publisher or the ad exchange may use the information in the ad orders to match particular ad orders to particular ad inventories as the ad inventories become available.

Ad inventories may become available or unavailable as time passes, typically as ad spaces become available or unavailable. An ad space may become available when the webpage containing the ad space is to be constructed and presented to a visitor, which may be resulted from different types of events. For example, a visitor may explicitly request a particular webpage by entering the Uniform Resource Locator (URL) of the webpage in the visitor's browser on the client device used by the visitor. Alternatively, a visitor may click on a link of a particular webpage embedded in another webpage that the visitor is viewing and be led to the particular webpage. A visitor may also request a search engine to conduct a search on a search query, which may result in a webpage being constructed for presenting the search result identified in response to the search query to the visitor. When the webpage needs to be constructed for a particular visitor, an ad space may become available if an area in the webpage is to be used for placing an advertisement. The visitor associated with an ad inventory is often the person who caused the ad space to become available and to whom the advertisement placed in the ad space is to be presented. Consequently, an ad inventory associated with that ad space may become available. Of course, the ad-space features and the user intent included in each ad inventory may vary each time an ad inventory becomes available.

As each ad inventory becomes available, the publisher owning the ad inventory may match the ad inventory to one or more ad orders of one or more advertisers. Alternatively, an ad exchange may match the ad inventory to one or more ad orders of one or more advertisers on behalf of the publisher owning the ad inventory. Each ad order may include one or more desired features of the ad spaces in which to place the advertisement of the ad order or one or more desired features of the visitors to whom the advertisement of the ad order is presented partly because not all available ad inventories at any given time may be suitable to an advertiser. For example, if an advertiser only wishes to target its advertisements to female visitors because it is advertising women's clothing, then the advertiser may not wish to bid on any ad inventories containing ad spaces to be presented to male visitors. An advertiser may also wish to only advertise with certain publishers (e.g., Yahoo!). In this case, the advertiser is unlikely to select any available ad inventories owned by other publishers (e.g., Google). An advertiser may wish to place its advertisements only in ad spaces presented within a certain geographical area (e.g., California) or during certain time periods (e.g., during day time on weekends) and thus may only wish to bid on those ad inventories that satisfy its digital campaign criteria. These criteria may be reflected in the various desired features specified for the ad orders of the advertiser.

In particular embodiments, when an ad inventory becomes available, the desired features of each of the ad orders may be compared to the ad space and the visitor of the available ad inventory. If there is sufficient similarity between the desired features of an ad order and the ad space and the visitor of the available ad inventory, or if the ad space and the visitor of the available ad inventory satisfy the desired features of an ad order, particular embodiments consider the available ad inventory as a suitable match to the ad order. Note that it is possible that multiple ad orders of the same advertiser or multiple ad orders of multiple advertisers may match an available ad inventory at the same time. Using the above example, if the visitor of the available ad inventory is a male, then it may not be deemed suitable to an ad order specifically targeting female visitors. Conversely, if the visitor of the available ad inventory is a female, then it may be deemed suitable to the ad order. If the ad space of the available ad inventory is to be presented at 10:00 pm on a Monday, then it may not be deemed suitable to the ad order specifically targeting ad spaces presented during day time on weekends. Conversely, if the ad space of the available ad inventory is to be presented at 10:00 am on a Saturday, then it may be deemed suitable to the ad order.

In another example, if the ad-space in the ad inventory is contained in a webpage constructed to present the search result identified in response to a search query “Napa wineries” and the keywords contained in an ad order include “red wine,” “white wine,” “Pinot Noir,” “Chardonnay,” or “Cabernet Sauvignon,” then the ad inventory may be suitable for the ad order because the content of the advertisement contained in the ad order is related to the search query that causes the webpage containing the ad space to be constructed. If the webpage containing the ad space is to be presented to a visitor located in California and the desired visitor features in an ad order indicate that the ad space should be presented to visitors physically located in California, then the ad inventory may be suitable for the ad order because the desired ad-space features in the ad order are similar to the actual ad-space features in the ad inventory. Conversely, if the ad space should be presented to visitors located on the East Coast of the United States, then the ad inventory may not be suitable for the ad order.

In particular embodiments, the publisher owning the available ad inventory or the ad exchange representing the publisher owning the available ad inventory may inform the appropriate parties managing those ad orders that are considered to match the available ad inventory of the available ad inventory and call for bids on the available ad inventory. Conversely, advertisers that do not have any ad order for which the ad inventory may be suitable may not be notified of the ad inventory. Note that multiple ad inventories owned by a publisher may be available at any given time. In the case where the publisher employs an ad exchange, the publisher may notify the ad exchange of all of its available ad inventories at any given time, and the ad exchange may in turn call for bids on each of the available ad inventories on behalf of the publisher. If the publisher manages its own ad inventories, the publisher may call for bids on each of its available ad inventories directly. As an example and not by way of limitation, a cost-per-impression bid is the maximum amount of money an advertiser is willing to pay for placing one of its advertisements in an ad space of an ad inventory. Other typical bid models include cost-per-mile, cost-per-click, and cost-per-action.

When an ad inventory becomes available, the publisher that owns the ad inventory may request multiple advertisers to bid on the ad inventory. Alternatively, advertisers may submit bids in advance of an ad inventory being available in anticipation of the ad inventory becoming available. Each of the advertisers wishing to place its advertisement in the ad space of the ad inventory may submit a bid for the ad inventory. The publisher may then select a winning bid (such as, for example, the highest bid, the bid the publisher believes will generate the most volume or revenue) and the advertiser submitting the winning bid may have its advertisement placed in the ad space and presented to the visitor of the ad inventory. If a webpage contains multiple ad spaces and thus causes multiple ad inventories to become available, the publisher may conduct individual auctions for each ad inventory or one auction for all the ad inventories and then select multiple winning bids for the multiple ad inventories. However, not all ad inventories are sold via auctions. In particular embodiments, a contract may exist between a publisher and an advertiser that governs the selling of the ad inventories from the publisher to the advertiser. In particular embodiments, ad inventories may be sold via an ad network.

Publishers may sell their ad inventories directly (such as in the case of search engines) or via a third-party service platform, which may be referred to as an advertising exchange (or ad exchange). An ad exchange may facilitate the bidding process of the ad inventories on behalf of the publishers. In particular embodiments, when an ad inventory becomes available, an ad exchange may be notified with the specific information concerning the ad inventory. The ad exchange may in turn notify the advertisers about the ad inventory and ask the advertisers to bid on the ad inventory. The advertisers may submit bids to the ad exchange, and the ad exchange may select a winning bid and forward the information to the publisher. The winning advertiser may then place one of its advertisements in the ad space of the ad inventory. Example ad exchanges include, without limitation, AdECN, RIGHT MEDIA, and DOUBLECLICK.

Some advertisers may interact with publishers or ad exchanges directly, which may include, for example, monitoring available ad inventories, determining bid amounts, and submitting bids. Other advertisers may employ third-party brokers to manage their digital-marketing campaigns and interact with the publishers or ad exchanges on their behalf. In particular embodiments, the brokers may attempt to achieve the advertisers' marketing objective for the digital-marketing campaigns by customizing various aspects of the marketing activities.

Advertisers may face challenges in managing ad inventories and placing appropriate ad orders. As an example and not by way of limitation, an advertiser may have difficulty anticipating possible search engine queries and selecting appropriate keywords to bid on. Users can enter nearly any query into a search engine, which means that the list of keywords a marketer can bid on may be enormous. However, in practice, there are limits on the number of keywords on which advertisers can bid. Advertisers may not have the capacity to manage such enormous numbers of keywords. Furthermore, search publishers may set limits on the number of keywords an advertiser can have in its account; and not all keywords will be relevant or profitable for a given advertiser. Given the vast number of potential keywords, it may be a challenge for advertisers to systematically anticipate and select keywords that will achieve their marketing objectives, such as, for example, driving the highest volume and quality of clicks with the least amount of cost.

Once keywords are selected, the advertiser may want to maximize campaign performance by systematically and consistently grouping the selected keywords. Text ads or ad copy are typically not assigned to individual keywords. Rather, they are assigned to groups of keywords, called ad groups. As such, how keywords are grouped is important because ad groups determine which ad can be shown once the keyword is matched to a query, which in turn impacts volume, conversion, and return-on-investment.

Once ad groups are created, the advertiser may assign ad copy to each ad group. To improve conversion, the advertiser will typically attempt to make the text ads as relevant as possible to all the keywords in the ad group. The advertiser may, for example, review each ad group and manually write relevant ad copy for each group. However, by using this approach it may be challenging for the advertiser to consistently determine the relevance between ad copies and ad groups. Furthermore, this approach may present challenges in scalably optimizing the relevance of ad copies across a large campaign with numerous ad groups.

Once ad copy is assigned to each ad group, an advertiser may assign a click-through URL or landing page to the ad copy or to the keyword. To improve conversion, the advertiser may make the URL or landing page as relevant as possible to the keyword matched to the query and to the ad copy displayed to or clicked on by the user. However it may be challenging and time consuming for advertisers to create highly relevant landing pages for each keyword or ad copy combination or to choose the most relevant landing page from among an existing set of landing pages for each keyword/ad copy combination. This may be achieved, for example, by using product facets on the advertiser's website or by directing the user to a search results page where the search is performed using the keyword or query or related user information.

Next, an advertiser may place a bid (typically on a cost-per-click basis) on a keyword. However, if the advertiser has never bid on a keyword or shown a given keyword/ad copy/landing page combination, the advertiser may not have an accurate idea of an appropriate cost-per-click bid on the keyword. The advertiser may choose an arbitrary cost-per-click, but if the cost-per-click bid is too low, the keyword may not be displayed by the search engine and consequently may never receive any clicks. In contrast, if the cost-per-click bid is too high, the advertiser may lose a significant amount of money on the keyword before the bid can be adjusted. As such, advertisers may desire to leverage prior campaign-performance data to better estimate appropriate cost-per-click bids for keyword/ad copy/landing page combinations that have little or no performance history associated with them.

Once bids are placed on keywords, an advertiser may attempt to optimize their campaign on an ongoing basis. For example, the performance data of deployed keywords may be used to improve the selection of additional keywords. As another example, ad groups may be revised and new ad groups may be formed in response to performance data. Similarly, ad copies and landing pages may be revised based on performance data. For example, the same ad copy may perform well for one ad group and poorly for another ad group, and performance data may be used to predict which ad copy will work well for a given ad group. As another example, some elements of a landing page may perform well for one ad group and poorly for another ad group, and performance data may be used to predict which landing page elements will work well for a given ad group. Performance data may also be used to optimize bids on keywords. For example, performance data could be used to “pause” bids on certain keywords (for example, by setting a bid to zero). As another example, performance data could be used to identify negative keywords, which are keywords that, if included in a query, indicate that an ad inventory should not be matched to the ad order, even if other elements of the query match closely to the other elements of the keyword. However, optimizing any of these campaign elements may be challenging because of the lack of data for determining statistically significant trends. As such, it may be challenging for advertisers to optimize bids, keyword selection, ad copy, ad groups, landing pages, or other campaign elements due to a lack of statistically significant data. And advertisers may find it undesirable to wait for time to pass so that more data can be collected.

Most search engines (e.g., Google) employ a concept similar to the quality score metric. A quality score is intended to reflect the search engine's perception of how relevant a user whose query is matched to an advertiser's keyword will find the advertiser's landing page to the query and/or the advertiser's displayed ad copy. A search engine may use the quality score to promote ads that it believes will lead to a more relevant user experience. The search engine automatically assigns a quality score to each keyword, and, if a quality score is low, the corresponding ad can appear very far down a search results page (or, even worse, the keyword can be automatically deactivated by the search engine). However, the assignment of quality scores by a search engine may be inconsistent, making it a challenge for advertisers to predict the quality score for any keyword/ad copy/landing page combination. Low quality scores or declines in quality scores may adversely affect an advertiser's campaign by lowering volume, conversion, and consequently lowering the return-on-investment on the campaign. Thus, a challenge for these advertisers is how to systematically improve or maintain the quality scores of their keywords.

In particular embodiments, electronic advertisements may be targeted to one or more consumers or types of consumers. Targeting can improve the match between consumers' interests or wants and the advertisements notifying the consumer of the availability of one or more advertiser's products. For example, certain products from an advertiser's catalog or inventory (“catalog” and “inventory” are used interchangeably, where appropriate) may better match a consumer's interests than other products from that inventory. For example, a consumer entering a search query of “green leather purse” is likely to find ads for leather purses more engaging than canvas purses, and ads for green purses more engaging than ads for yellow purses, generally. The consumer is more likely to view, show interest, and buy products that most engage the consumer. Thus, targeting consumers with advertisements for the products that the consumer is most likely interested in improves outcomes for the consumer and the advertiser.

As another example of targeting, certain advertisements may be more engaging to specific consumers than other advertisements are, even when advertising the same set of products. Thus, advertisements themselves may be targeted to consumers based on how those consumers may respond to the advertisements. For example, an advertisement that emphasizes certain features of the product that the user is most interested in may fare better than an advertisement that only identifies the product being advertised. As another example, an advertisement that contains elements related to the price of the products (such as a description that the product is “on sale!”), the number of products left, and/or the location of the product being sold may be more engaging than advertisements that do not contain those elements. As another example, grammatically correct ads may be more engaging than grammatically incorrect ads. In particular embodiments, targeting may include targeting products to a consumer, the contents and format of an advertisement to a consumer, or any suitable combination thereof. In particular embodiments, “ad copy” refers to the content and format of an advertisement.

Targeting may require an entity in the digital marketing campaign, such as the advertiser, to determine a consumer's intent, the product(s) in a seller's inventory that best correspond to that intent, and the advertisement(s) for those product(s) that most effectively engage the consumer. An advertiser may attempt to target by creating ad campaigns directed towards specific types of products. For example, for an electronics retailer, one ad campaign may be “televisions,” and another may be “appliances.” However, those categories may be too broad to effectively target most consumers, i.e., one consumer may be looking for a refrigerator while another is looking for a microwave. Thus, an advertiser may create groups of ads within an ad campaign that more finely target consumers. The groups of ads, or “ad groups,” may be associated with targeting information such as keywords, similar products, consumer location, time of day, and the like. Targeting then occurs based on characteristics or interests of consumers who match the targeting information associated with the ad group, such as, for example, to consumers who use the keywords in a search query or who visit webpages that provide information about similar products. This disclosure contemplates targeting advertisements based on any suitable information about or actions of a consumer. This disclosure contemplates associating an ad or ad group with any suitable targeting information.

Targeting may require significant resources, for example to effectively manage ad campaigns, ad groups, and targeting information associated with those ad groups. Effective targeting may require updating ad campaigns, ad groups, and targeting information (such as keywords) associated with those ad groups based on how effective those ad campaigns, ad groups, and targeting information associated with those ad groups are in engaging particular consumers. In addition, an advertiser may be required to review their inventory, which may change over time, and add and remove products from ad groups and ad campaigns based on effectiveness and availability. Moreover, consumer preferences and interests may change over time, as may the traits or characteristics that correlate with consumers having those preferences or interests. And because targeting often becomes more effective as more consumer traits, preferences, and actions are taken into account, an advertiser may be required to manage a large number of different ad campaigns, ad groups, and targeting information associated with those ad groups in order to successfully advertise. Thus, managing a successful advertising program may require an advertiser to gather, review, and analyze a large volume of information that changes over time, and to frequently update its advertising strategy accordingly.

Customizing advertising campaigns for specific segments of consumers often improves campaign performance, which in turn improves outcomes such as the volume of sales from, the revenue generated by, or the return-on-investment of the advertising campaigns. The “best” (or the most customized user experience) is often a function of an advertising value chain. At each stage along an advertising value chain, advertising campaign customization for any given consumer should take into consideration not only relevant information on the current stage along the advertising value chain but as much relevant information as is available from previous stages along the advertising value chain as well. As an example and not by way of limitation, the “best” advertisement (ad) for a particular consumer may be a function of how the advertiser purchases the advertising media; who the consumer (also referred to as a “user” or “visitor”) being targeted is; which publisher publishes the advertisement; the placement of the advertisement; the corresponding search term (if applicable); whether the consumer has previously visited the web site or the advertiser; other consumer/user information, or two or more such factors. The “best” landing page for a particular user may be a function of how the advertising media is purchased; what corresponding advertisement has been presented; where in the advertisement the consumer has clicked; or other suitable factors. Optimization that does not take into consideration relevant information from previous stages of the advertising value chain may lead to suboptimal campaign performance.

Given the volume of ever-changing information that may need to be gathered and analyzed to run an effective advertising campaign, a knowledge base may be used to store information relevant to an advertiser's products and advertising campaigns. Information may take any suitable form, such as text, pictures, metadata, websites, etc. As described more fully below, information may include raw data, such as an advertiser's products, and may include enriched data, such as products that are synonymous with those products. A knowledge base can take, and be represented in, any suitable form, such as a database, an information graph, or any suitable combination thereof. In particular embodiments, a knowledge base may be divided into, or stored as, two or more knowledge bases. In particular embodiments, a knowledge base may contain information about one particular industry, or “vertical.” In particular embodiments, a knowledge base may contain information about multiple verticals.

FIG. 2 illustrates a portion of a knowledge base represented as an information graph 200. As illustrated in FIG. 2, graph 200 may consist of nodes 205 representing concepts such as products, services, locations, words, attributes or any other suitable concept; and edges 210 connecting nodes and describing the relationships between them. As used herein, “concept” may include both the idea or thing the concept represents, the label for that idea or thing, any suitable information associated with that idea or thing, or any suitable combination thereof. In particular embodiments, graph 200 may be stored or represented as a hierarchical structure. In particular embodiments, the hierarchical structure may represent that nodes at a higher layer (i.e., closer to the root layer) of the hierarchy encompass related nodes at a lower layer. For example, a “clothing” node may be at a higher layer than “shirt” in a hierarchical information graph. In particular embodiments, a hierarchical structure may represent that a node at a higher layer of the hierarchy can be described by nodes at one or more lower layers. For example, “shirt” may be at a higher level of hierarchy than “red.” As implied by the previous example, in particular embodiments a hierarchy may be related to parts of speech, in that nouns, or words used as nouns in a word phrase, are at a higher layer of the graph than adjectives are. In particular embodiments, one or more edges 210 may be unidirectional, bidirectional, or nondirectional.

An information graph may be used to target advertisements. For example, nodes in the information graph may represent concepts such as the categories of products a retailer offers (e.g., “wearables”), specific products within those categories (e.g., “shoes”), specific brands (e.g., “Nike”), specific models associated with a brand (e.g., “Air Max”) and specific attributes and corresponding values for those products (e.g., “U.S. size—men's 9.5” or “color—red”). While the previous examples describe specific types of nodes in an information graph, this disclosure contemplates any suitable type of node. In particular embodiments, separate graphs or portions of graphs may be used to represent different kinds of data. FIG. 3 illustrates a knowledge base represented as an information graph 300. Data in graph 300 may be organized by raw data 310, advertiser's data 320, and enriched data 330. For example, a graph or portion of a graph may be used to represent raw data representing information describing an advertiser's catalog of products at a particular point in time, as retrieved from a particular data source, such as a website. As used herein, “catalog” refers to an advertiser's offering of products or services, or any portion thereof, regardless of the format or medium in which those products and services are identified, stored, or communicated. As described more fully below, raw data may be collected by any suitable method and in any suitable form.

Raw data may be represented by a portion of an information graph. As illustrated by the raw data 310 in FIG. 3, in particular embodiments raw data may include information about products, product categories, attributes, attribute values, and associated information such as the source of the raw data (e.g., a uniform resource locator, or URL), the date on which the raw data was gathered, and the like. In particular embodiments, each piece of raw data may be represented by a node in the graph, and the relationships between the raw data (e.g., that “shape” is an attribute of an “Christmas ornament” product) may be represented by edges between nodes. In particular embodiments, nodes may represent collections of raw data. For example, a node may represent a product, along with where information about that product came from, or any other suitable information. In particular embodiments, raw data may be organized in an information graph in the same way the data is organized in the raw data source. For example, raw data pulled from an advertiser's website may be organized as the website is organized, i.e., according to the “breadcrumb” that the advertiser established for their own catalog. As an example, one advertiser may categorize a “cookie sheet” as a type of “dish” on its website, while another may characterize “cookie sheet” as a type of “pan.” Each advertiser's taxonomy would be reflected in the raw data stored in the information graph for that advertiser. In this example, “cookie sheet” may be stored as separate nodes, one for each advertiser, or may be stored as a single node with information, such as edges, describing how each advertiser characterizes their own catalog. In particular embodiments, raw data may be stored as-is, without any graph structure.

An information graph may also store advertiser-specific data, such as in an advertiser graph 320. For example, raw data from several sources, such as multiple websites crawls, or from a website crawl plus manual entry, or from a product or merchant feed provided as a .csv file or downloaded from a publisher site plus manual entry, may be consolidated and represented in the information graph. For example, suppose a crawl of an advertiser's website discovers a “bouncy ball” product in a “children's toys” category, and that the advertiser's catalog contains “bouncy ball” products with “color” attributes having the values “red,” “blue,” and “green.” If a subsequent crawl of the advertiser's website catalog, or any other suitable method of retrieving the data about the advertiser's catalog, discovers a “bouncy ball” product with a “color” attribute having the value “yellow,” that information may be represented in the advertiser's specific graph by adding a node with the value “yellow” to the portion of the graph describing the “bouncy ball” product, adding the value “yellow” to information associated with an existing node describing at least some of the attributes of the “bouncy ball” product, or by creating a relationship, such as any suitable edge, between that portion of the graph and an existing node associated with the color “yellow.” In particular embodiments, an advertiser-specific graph follows the advertiser's organization of its own catalog, such as, for example, the organization at least partially identified by the breadcrumb associated with the advertiser's on-line catalog. In particular embodiments, the advertiser-specific graph and the raw data may be connected or related to each other. For example, a “product” node in the advertiser-specific graph may be associated with each instance of that product found from one or more data pulls of the advertiser's catalog. This description contemplates describing an advertiser's catalog using any suitable nodes in any suitable organizational structure associated with any suitable information and connected by any suitable relationships. Moreover, this disclosure contemplates any suitable data structure for storing or representing information about an advertiser's catalog.

An information graph may include a portion that a represents a vertical, multiple verticals, or a portion thereof and is enriched with information beyond that contained in any one advertiser's catalog. For example, enriched graph 330 of FIG. 3 may contain data that has been enriched from raw data obtained from a plurality of advertisers. In particular embodiments, “enrichment” includes associating information with other information; organizing or structure data (such as, for example, in a different hierarchical structure than that in which the data was received); creating relationships between information (such as, for example, between nodes in the graph); creating, removing, or combining nodes or portions of nodes, or any suitable combination thereof. As an example, a Product node in an enriched graph may be a normalized product node representing product nodes from multiple advertiser-specific graphs. For example, one advertiser-specific graph may contain a product node for a “Nike Air Max Shoe—Men's Size 9, Red,” another advertiser's specific graph may have a product node for “Red, Men's Size 9 Nike Air Max Shoe,” and yet another may have a product node that describes the UPC code for the red, men's size 9 Nike Air Max shoe. Each of those nodes be condensed into a single node in the enriched graph, or represented as a single collection of nodes, thus identifying that each node in the advertiser-specific graphs, and each product those nodes represents, are actually identical concepts, even if described in different formats or using different language. Thus, catalogs from multiple advertisers may be reproduced from a single enriched graph. As used herein, a specific type of node in an enriched graph may be represented by placing the name of the node in “ ”, capitalizing the name of the node, or placing the name of the node in < >.

In particular embodiments, nodes in an enriched graph may include Category nodes. As for Product nodes, Category nodes may be normalized category nodes from multiple advertiser-specific graphs. In addition or the alternative, Category nodes in an enriched graph may describe a taxonomy that differs from that described by an advertiser's catalog. For example, one advertiser may categorize a “cookie sheet” product as a “dish,” while another may categorize “cookie sheet” under “pans”,” while yet another may categorize “cookie sheet” under “kitchen items.” The enriched graph may categorize “cookie sheet” under any or all of those Category nodes, or may categorize it under a new node, such as “bakeware.” As this example shows, an enriched graph may contain use multiple nodes to describe or categorize concepts, such as product and product categories. In particular embodiments, connections between nodes provide information about the relationships between concepts, i.e., that “cookie sheet” may be properly categorized as a “pan,” as “bakeware,” as a “kitchen item,” etc. In particular embodiments, the connections between nodes may be used to determine relationships between nodes that are not directly connected to each other. For example, in the previous example “pans,” “bakeware,” and “kitchen items” may be considered related concepts, as they are all related to a “cookie sheet” node in the enriched graph. Thus, as described more fully herein, the relationships present in an enriched graph may be used to determine which concepts are related to each other and how they are related to each. As described more fully herein, such information may result in more finely targeted advertising, as different users may illustrate their interest in the same product, i.e., a cookie sheet, using different words or by looking at different products. Likewise, different advertisers may represent the same product through different words or through different organizational structures. An enriched graph thus provides an advertiser access to many different organizational structures and descriptions of products beyond what its own catalog contains. The advertiser can then select, or have automatically selected for them, the descriptions and structures in the enriched graph that best advertise specific products in the advertiser's catalog to specific consumers.

In particular embodiments, nodes in an enriched graph may include Product Type nodes. In particular embodiments, Product Type nodes describe types of products that specific Product nodes relate to. For example, a specific size and color of a Nike Air Max shoe may be represented by a specific Product node, which connects to a Product Type node “shoe.” Like for any type of node in an enriched graph, particular Product nodes in an enriched graph may be related to two or more Product Type nodes. For example, a Nike Air Max shoe may be related to (such as, for example, a child of) both a “shoe” Product Type node and an “athletic wear” Product Type node, both of which may be related to a “wearables” Category node. As described above, connections between nodes may provide an advertiser of a specific product targeting information, such as keywords or information about related products, beyond the information its own catalog contains. In addition or the alternative, multiple advertisers' catalogs can be generated from a single enriched graph, as that graph contains the necessary information and connections to reproduce any one advertiser-specific graph. In particular embodiments, a Product Type node may also serve as a Category node for certain products, and vice versa.

In particular embodiments, nodes in an enriched graph may include Attribute nodes. In particular embodiments, Attribute nodes describe attributes associated with other nodes, such as Product nodes, Product Type nodes, and Category nodes. For example, an Attribute node may be “color” which may be associated with particular products. In particular embodiments, an attribute may correspond to one or more adjectives or adjectival phrases that describe a noun in written language. For example, in a graph associated with retail products, Attributes may include size, price, location (e.g., geographical), material, finishing, brand, warranty, retailer or seller, or any other suitable descriptions or properties of one or more retail products in the graph. In particular embodiments, one or more attributes may be encompassed by other nodes, such as Product nodes, indicating that the attributes corresponding to the Attribute nodes describe the products corresponding to the Product nodes, in at least one iteration or substantiation of that product.

In particular embodiments, nodes in an enriched graph may include Attribute Value nodes. Attribute Value nodes may describe specific values of Attributes with which they are associated. For example “red” and “blue” may be Attribute Value nodes associated with a “color” Attribute node. Attribute Value nodes in an enriched graph may occur at any suitable level of granularity. For example, in particular embodiments different shades of red may each be associated with a “color” attribute node. As another example, different shades of red may be child nodes of the “red” Attribute Value node, indicating that each shade is itself an Attribute Value that is a child of one or more other Attribute Values. In particular embodiments, an Attribute Value node may be associated with Product nodes, indicating that a particular product, such as an Nike Air Max shoe, is associated with specific attribute values, such as sizes “9” and “9.5” or colors “red” and “blue.”

In particular embodiments, nodes in an enriched graph may include nodes describing particular aspects of consumer interests and intentions. For example, any of the nodes described above may also be nodes that represent expressed or implied consumer intent. As another example, nodes describing consumer intent may be Purchase Intent nodes, such as, for example, Buy nodes, Sign Up nodes, Register nodes, On Sale nodes, Discount nodes, or any other suitable node indicating consumer interests.

In particular embodiments, nodes in an enriched graph may include Call to Action nodes such as, for example, Purchase nodes, Compare nodes, Reviews nodes, or any other suitable node indicating some action a consumer may take or a description of that action. In particular embodiments a Call to Action node may also be a Purchase Intent node, or vice versa.

In particular embodiments, nodes in an enriched graph may be organized in a hierarchical structure. For example, Category nodes may be situated at the highest layer of an enriched graph's hierarchy, Product Type nodes may be situated at the layer below Category nodes, Product nodes may be situated at the layer below Product Type nodes, Attributes nodes may be situated at the layer below Product nodes, and Attribute Value nodes may be situated at the layer below Attribute nodes. As described herein, in particular embodiments information in the enriched graph, such as product nodes or any other suitable node, may be connected to information in advertiser-specific graphs or to raw data. While this disclosure describes specific types of nodes in an enriched graph, this disclosure contemplates any suitable nodes connected in any suitable manner, describing any suitable concepts, and associated with any suitable information. Moreover, while this description describes particular types of nodes as belonging to an enriched graph, this description contemplates such nodes residing in any suitable graph, such as an advertiser-specific graph.

In particular embodiments, an information graph contains edges connecting nodes and describing, at least in part, relationships between nodes. For example, an enriched graph may include edges connecting nodes. In particular embodiments, an edge may, by itself, indicate the existence of some relationship. For example, an edge connecting an Attribute Value node in an enriched graph to Product node in the same graph may indicate that at least one substantiation or version of the product represented by the Product node has the attribute value represented by the connected Attribute Value node. In particular embodiments, edges may be of a specific type or kind, which provides additional information about a node or about a relationship between nodes, as described more fully below. In particular embodiments, an edge may be a one-way edge, indicating that one node modifies or is related to another. In particular embodiments, an edge may be a two-way edge, indicating that the information described by the edge applies to both nodes.

In particular embodiments, information in an enriched graph identifies and describes specific relationships between the concepts represented by nodes. For example, in an enriched graph that describes concepts linguistically, information identifying and describing relationships may include senses or meanings of a word, such as synonyms, antonyms, hyponyms, hypernyms, homophones, homographs, homonyms, and any other suitable sense. As an example, an enriched graph may contain a “car” node and a “vehicle” node, for example because advertisers may use those words in their own catalogs to describes their own products, or because consumers use those words when looking for particular products. The enriched graph may contain information, such as an edge or referenced data in a database, indicating that “car” and “automobile” are synonyms of each other. In particular embodiments, sense and/or meaning may apply to collections of words and/or collection of nodes. For example, “as the crow flies” may be considered synonymous to “in a straight path.” Other information may be relevant to senses or meanings of a word, such as capitalization (e.g., “frost” the condensate vs. “Frost” the poet) or punctuation. In particular embodiments, information describing senses or meanings between words or collections of words may include “key” meanings, which may describe the “overlap” between senses or meanings of words. For example, “sedan” and “car” may have overlapping meanings, but “sedan” may be better described by “four-door car.” Thus “four-door car” may be considered a key sense of “sedan,” while “car” may be considered to be a synonym of “sedan.” In particular embodiments, senses or meanings may include “alternatives.” For example, one advertiser may sell a “Jaguar” operating system for Macintosh computers, while another advertiser may sell the “Jaguar” brand of cars. Each advertiser may have a “Jaguar” node in that advertiser's specific graph. In the enriched graph, there may be two nodes for “Jaguar”: one being a Product node representing the operating system, and another being an Attribute Value node representing the value “Jaguar” for the attribute “brand.” The enriched graph may include information that the two nodes are alternative meanings of the same word, “jaguar,” for example by connecting the two nodes with an “alternate meaning” edge. While this disclosure describes specific types of sense or meanings of concepts in a graph, and specific ways of relating sense or meanings to other senses or meanings, this disclosure contemplates any suitable senses or meanings related in any suitable way.

In particular embodiments, information identifying and describing relationships in an enriched graph may include variants of concepts represented by nodes. For example, relationships may include variants of a word or collection of words, such as plurals, singulars, stems, misspellings, and the like. As an example, “beetles” may be a plural variant of “beetle,” while “betle” may a misspelling variant of “beetle.” Variants may be indicated by any suitable identifier, such as by a “variant” edge connecting two nodes, or by representing each variant as a node and associating those nodes with each other. While this disclosure describes specific types of variants, this disclosure contemplates variants of any suitable type.

In particular embodiments, information identifying and describing relationships in an enriched graph may include properties of concepts represented by nodes. For example, relationships may include properties of a word or collection of words, such as the word's part of speech (e.g., noun, verb, adjective, etc.), verb conjugation, stems, and the like. As an example, “blade” may have a property of being an adjective when used as in “blade coffee grinder,” but may have a property of being a noun when used as in “10-inch blade.” In particular embodiments, words or concepts having different properties may each be represented as a node in an enriched graph, and may be identified as variants of each other, for example through connections by “variant of” edges. While this disclosure describes specific types of properties, this disclosure contemplates properties of any suitable type.

In particular embodiments, weights may be used describe the strength of associations and relationships, such as edges between nodes in an enriched graph. A higher weight may indicate a stronger relationship, and a lower weight a weaker one. A negative weight may indicate that two things are relative “opposites” of each other. For example, in particular embodiments “luxury” may be the opposite of “cheap,” in the sense that a consumer looking for a cheap good or service is unlikely to be looking for a high-end, luxury version of that good or service. As another example, “sedan” and “four-door car” may be given a higher “synonym” weight than “sedan” and “vehicle” receives.

As described more fully herein, a graph enriched with the nodes, connections, and relationships described above significantly improves an advertiser's ability to target consumers' interests with specific products and advertisements. For example, an advertiser's catalog has a specific structure and has specific terms for specific products. The advertiser may not have any way of describing its products, thus any way of relating those products to each other and to consumers, beyond the structure and descriptions in its catalog. Or, the advertiser may have to manually create the alternative organization, descriptions, and relationships, in effect recreating its own catalog multiple times over. However, an enriched graph contains the descriptions, relationships, and organizations necessary to recreate not just the advertiser's chosen catalog, but also many variants of that catalog. Thus, the advertiser can target ads to consumers as if it had a catalog specifically made for individual consumers or groups of consumers, using the terms that audience finds most engaging, and using the terms that audience chooses to indicate its own intentions, i.e., the products it is looking for or interested in considering. In the same vein, the enriched graph enables an advertiser to avoid spending resources delivering advertisements and product to consumers who are unlikely to be engaged by them. For example, an advertiser selling “Jaguar” cars can avoid advertising to consumers looking for the “Jaguar” operating system because the user's intent to search for the operating system is made clear through its intentions (i.e., its actions) as explained by the nodes and relationships in the enriched graph, even though a user looking for the operating system may also use search terms highly relevant to the car dealer. Moreover, an enriched graph enables an advertiser to simulate competitor catalogs, for example by using the same or similar organization, relationships, and description used by competitors. Thus, an advertiser may neutralize advantages that a competitor receives at least in part from marketing, not from its underlying business.

Enrichment of a graph may occur by any suitable method. For example, data about one or more products may be used to enrich nodes or edges related to that product in the enriched graph. Such data may be obtained by any suitable method and may come from any suitable source, such as crawls of websites, queries, analysis of existing ads, etc. If a website crawl reveals that a specific set of wine glasses come in 4-packs, while the product is only associated with 8-packs in the enriched graph, the graph may be enriched by associating the 4-pack information by any suitable method, such as a by adding a Product node to the enriched graph, adding a “4-pack” Attribute Value node and associating it with the exiting wine glass product, or by adding an edge between an existing “4-pack” node and the relevant wine glass product node.

In particular embodiments, enrichment may occur by internal evaluation of an existing enriched graph. For example, evaluation of an enriched graph may reveal that a “car” node is related to a “vehicle” node, and that “automobile” is related to “car.” Based on the shared connection, a relationship between the “automobile” node and the “vehicle” node may be created. As another example, an enriched graph may contain a node for a certain product of shoe, and may contain relationships indicating that the shoe comes in women's size 6 in U.S. measurements. The enriched graph may also contain a relationship between women's size 6 in U.S. measurements and women's size 3.5 in U.K. measurements. Based on the existing relationship, a relationship may be created between the particular shoe product and the “size 3.5 in the U.K measurements.” Enrichment may enable an advertiser to easily advertiser its shoe products to consumers that prefer measurements in units other than those the advertiser describes in its catalog. This disclosure contemplates enriching a graph through evaluation of any suitable portion of the graph using any suitable method.

In particular embodiments, enrichment may occur through the use of one or more disambiguators, such as for example and without limitation Google Refine, Silk, DbPedia spotlight, any other suitable disambiguator, or any suitable combination thereof. Data either from within the enriched graph or external to the enriched graph may be analyzed, parsed, and disambiguated, and the resulting refined data may be analyzed and used to enrich the graph. For example, a disambiguator may analyze the words nearby a word that is represented by an existing node in an enriched graph, and, based on that analysis, determine whether the word is in fact the concept represented by the existing node, or a new concept deserving its own node in the graph. As an example, a disambiguator analyzing a collection of search queries such as “computer jaguar OS,” “install jaguar on my mac,” “jaguar latest software version,” and “boot mac to jaguar” may determine, based on the context of the phrases taken individually and collectively, that “Jaguar” corresponds to a particular operating system for Macintosh computers and thus is different from an existing node “Jaguar” referring to the animal or to a brand of automobile. The new node “Jaguar” representing the operating system concept may be created, and the context (i.e., related words in the search queries above) used to disambiguate the new “Jaguar” node from the other “Jaguar” nodes may be used to create relationships in the enriched graph, for example, by creating edges between the new “Jaguar” node and “computer,” “operating system,” “software” and any other suitable existing or newly added nodes. While the examples above describe enriching a graph based on information disambiguated from search queries, this disclosure contemplates enriching a graph based on any suitable analysis of any suitable information. For example, information about products a consumer is viewing that contain attributes similar to products represented by existing nodes in the graph, or information about various retailors' categorization of products based on breadcrumbs describing on-line product catalogs, may be disambiguated or otherwise analyzed and used to enrich a graph.

In particular embodiments, nodes and relationships may be added, edited, or removed only if the basis for the additions, edits, or removals meets a certain reliability threshold. For example, in the “Jaguar” example above, “fast Jaguar” may be insufficient to create a new Jaguar node, as the context “fast” may be likely to apply to a car as well as to a piece of software or the animal. In contrast, one of the search phrases described in the paragraph above may be sufficient to create a node or relationship on a temporary or probationary basis. Several of the search phrases above, or similar ones indicating that “Jaguar” is an operating system, may be sufficient to create the node and the relationships on a permanent basis.

In particular embodiments, enrichment may occur manually, automatically, or any suitable combination thereof. For example, adding nodes and relationships may occur based on manual review of raw or filtered data. As another example, any suitable statistical algorithms or machine-learning algorithms may be used to analyze data and determine whether enrichment should occur. For example, Attribute Value nodes for an existing Product node may be suggested or created based on analysis of product name, description, or other fields associated with that product in data retrieved from an external source, such as a website crawl. In particular embodiments, enrichment may occur through the use of interaction between an automated system and a human user, such as an automated question-and-answer system, or “Mechanical Turk”-type system. For example, an automated system may present a set of options to a human, who can select none, one, or more than one of the options presented. For example, an automated system may suggest a number of Category nodes that a potentially new Product node could be associated with, and a human may select which Category nodes, if any, are most applicable to the Product node. In particular embodiments, the automated system may employ any suitable active-learning algorithm. In particular embodiments, the automated system may learn from the human feedback, for example by revising specific questions it asks or the type of questions it asks. For example, if the automated system does a particularly poor job determining how to categorize Product nodes, but does well at determining what Attribute Value nodes to add for specific Attribute nodes, then the system may present fewer questions or selections about enrichment related to Attribute Value nodes and more questions or selections about categorizing Product nodes. In particular embodiments, a confidence value may be assigned to automated enrichment decisions, and if the confidence value falls below a specified threshold, then the decision may be flagged for manual review.

As described above, all or a portion of an enriched graph may be related to one or more advertiser-specific graphs. Thus, the enriched graph can be used to create subsets of enriched graphs corresponding to an advertiser's catalog, presented in the structure of and language used by that advertiser's catalog. The information in the enriched graph corresponding to an advertiser's specific graph can be used to target advertisements at or near real-time. For example, information in an enriched graph may improve the effectiveness of targeted advertising, as user interests can be determined, analyzed, and targeted using the enriched information, not just the advertiser's catalog information. Likewise, keywords and products similar to those offered by an advertiser can be selected based on enriched information, not just on the descriptions and product identifications identified in the advertiser's catalog. Moreover, non-text data, such as pictures, can be taken from an enriched graph and used to present products to consumers, rather than using only the non-text data that is available from the advertiser's catalog. In addition or the alternative, an enriched graph can be used to create ad groups containing finely targeted ads, and ad campaigns with finely targeted ad groups. Moreover, an enriched graph can provide multi-tenancy, i.e., a single, master enriched graph can create enriched advertiser-specific graphs, and thus enriched catalogs, for many different advertisers. Thus, in particular embodiments, if two advertisers sell the same product, there is no need for both advertisers to recreate each other's keywords because those keywords can be generated from the relationships and structure associated with the corresponding Product node in the enriched graph.

Similarly, an enriched graph may be used to enrich and refine information related to an advertiser's product catalog. For example, an enriched graph may be used to enrich and refine an advertiser's product feed. As an example, an enriched graph or a subset thereof, such as the enriched advertiser-specific graph for that advertiser, may be matched to the advertiser's product feed. The product feed may be enriched with information in the enriched graph or subset thereof. In addition or the alternative, errors in the product feed, such as spelling errors in words, syntactic errors in phrases, product-related errors such as incorrect UPC codes, or any other errors may be identified and corrected based on the information in the enriched graph. Likewise, the enriched graph may be used to correct errors in any other advertiser-related information, such as in the advertiser's product catalog. In particular embodiments, information in the product feed may be replaced with information from the enriched graph. For example, product descriptions may be replaced with the richer set of descriptions provided by the nodes, edges, and associated information in the enriched graph, for example through the use of synonyms, information from related or alternative Attributes and Attribute Values, and the like. As another example, the taxonomy of the product feed, such as the categorization of products, may be replaced by the richer and more detailed taxonomy from the enriched graph, as described, for example, by the relationships between and information contained in Product Type nodes. In particular embodiments, an advertiser may not have a product feed to provide to a publisher. In those embodiments, the enriched graph may generate a product feed based on, for example, information contained in the advertiser's product catalog and its related information in the enriched graph. Because in particular embodiments the advertiser's catalog may be determined from automated processes such as website crawls, an advertiser may not have any information generated about its catalog of products, yet, using the systems and methods described herein, may still generate product feeds for targeted advertising.

While many of the examples described above relate to retail industries, this disclosure contemplates that knowledge base and its representations, such as the graph structures described herein may apply to any suitable industry for advertising any suitable product. As an example, the graph structures described above may be used to advertise for one or more travel-based verticals. The graph structures encompassing a travel-based vertical may be referred to as a “travel graph.” In particular embodiments, a travel graph may include travel-related products, attributes, events (such as concerts, plays, etc.), geographical locations, landmarks, or the like. For example, a travel graph may include information about air travel (such as flights to or from specific destinations or on specific airlines) or any other common carrier, cruises, car rentals, hotels and lodging, vacation packages, sightseeing, theme parks, tours, or any other suitable travel-related information.

Raw data in a travel graph may be gathered by any of the methods described above, such as, for example, by crawling a hotel's website, a common carrier's website, or travel-aggregator websites (such as Kayak or Expedia). Raw data may be enriched by any of the suitable methods described herein to create an enriched travel graph. FIG. 4 illustrates an example enriched travel graph 400 with example nodes 405 and edges 410. As for any enriched graph, nodes in a travel graph may be associated with information, such as, for example, alternate senses and meanings, alternate names or other identifiers, geographical location (such as latitude and longitude), population, nearby or popular activities, points of interest (and, in particular embodiments, the location of or directions to the points of interest), or any other suitable information. In particular embodiments, information may be associated with or indicated by edges 410 connecting nodes 405, as described more fully herein.

FIG. 5 illustrates an example method 500 for gathering data and building, updating, and generating the various graphs discussed above. The example method of FIG. 5 may start at step 505, where data is gathered by any suitable method, such as, for example, a crawl of an advertiser's website, input manually by a retailor (for example, by using pre-determined templates), accessed from a data store such as a database, accessed from comparison shopping sites, accessed from information sites, accessed from aggregation sites such as search engines, accessed from a product or merchant feed provided by a retailor or downloaded from a publisher site, or any suitable combination thereof. The method may proceed to step 510, where the data is loaded into a knowledge base, such as for example the information graph illustrated in FIG. 3. In particular embodiments, each set of data gathered may be stored as raw data in the knowledge base. In particular embodiments, data may be filtered, sorted, loaded into pre-set categories, analyzed, or undergo any other suitable processing prior to or after being stored. The method may then proceed to step 515, where data is normalized based on the entity, such as an advertiser, that it belongs to. For example, as described more fully above, data gathered from a crawl of a retailer's website may be compared to data from previous crawls and used to add, edit, or delete a portion of an information graph representing the advertiser's catalog. The method may then proceed to step 520, where the data, either in raw or processed form, may be used to enrich an enriched graph, for example by using any suitable method described more fully herein. In particular embodiments, step 520 may further include updating the relationships between one or more advertiser-specific graphs and the enriched graph. At step 525 the method may export a portion of the enriched graph corresponding to one or more advertiser-specific graphs connected to the enriched graph, according to the relationships between the enriched graph and the one or more advertiser-specific graphs. The method may end at step 525. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for gathering data and building, updating, and generating graphs including the particular steps of the method of FIG. 5, this disclosure contemplates any suitable method for gathering data and building, updating, and generating graphs including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

As described more fully herein, a knowledge base such as an enriched graph may be used to create effective advertising campaigns by matching products and advertisements to consumer's interests and preferences. For example, an enriched graph may be used to determine consumer intents. As used herein, “consumer intents” may be used interchangeably with “user intents,” when appropriate. In particular embodiments, consumer intents may describe what a particular user's objective is, and may be derived or predicted from explicit or implicit user information. In particular embodiments, an enriched graph may be part of, or may interface with, an intent marketplace, which may include an exchange-based online marketplace where publishers may make available opportunities to advertise to users and where users may be described by their underlying intent (i.e., user intent). As used herein, the term “intent” may mean either an individual instance of a topic (which, in an enriched graph, may alternately be referred to as a “node,” where appropriate), such as, for example, topic=brand, intent=Puma; or a vector of individual instances of topics such as, for example, <brand=Nike>, <color=white>, unless context suggests otherwise. Furthermore, as used herein, this disclosure may use a shorthand to allow reference to multiple intent vectors (which may refer to a related subsection of the nodes, edges, and information in an enriched graph, where appropriate), such as, for example, <brand=Nike, Reebok, Adidas>, <color=all> refers to <brand=Nike>, <color=white>, <brand=Reebok>, <color=orange>, <brand=Adidas>, <color=black>, etc. For example, in particular embodiments, an intent marketplace that includes an enriched graph may derive consumer intents based at least in part on search queries from users. The intent marketplace may receive one or more user's search queries from a publisher. Once a search query is transmitted to the intent marketplace, the intent marketplace may analyze the search query to determine the consumer intent of the query. In particular embodiments, the intent marketplace may parse a query submitted by a user to determine one or more words or one or more words set of words. As an example and not by way of limitation, the intent marketplace may parse a search query for all n-grams. In general, an n-gram is a sub-sequence of n items from a given sequence. An n-gram of size 1 is referred to as a “unigram,” of size 2 is referred to as a “bigram” or “digram,” and of size 3 is referred to as a “trigram.” In particular embodiments, the intent marketplace may identify n-grams based at least in part on term-frequency-inverse-document-frequency (tf-idf) of one or more words (or terms) in a publisher's website. In particular embodiments, the intent marketplace may generate a set of n-grams based at least in part on term-frequency-inverse-document-frequency (tf-idf). Although this disclosure describes identifying n-grams using a particular algorithm, this disclosure contemplates identifying n-grams using any suitable algorithm. Moreover, although this disclosure describes identifying n-grams using particular variables that represent particular information, this disclosure contemplates identifying n-grams using any suitable variables representing any suitable information.

In particular embodiments, a search query n-gram includes each segment of the query. Due to the different combinations, there may be many search query n-grams constructed from the search query segments obtained from a search query. As an example and not by way of limitation, the search query “big apple taxis” includes the segments “big,” “apple,” and “taxis.” From this search query, the intent marketplace may construct the following n-grams: (big), (apple), (taxis), (big apple), (apple taxis), (big taxis), (big apple taxis). In particular embodiments, after parsing a query, the intent marketplace may determine one or more intents included in a query based on the one or more words or the one or more sets of words. As an example and not by way of limitation, once the intent marketplace has identified the possible n-grams, it may then determine which n-grams match with intents that are present in the intent marketplace. This may be done by referencing an enriched graph or a collection of enriched graphs, which may be stored by the intent marketplace. As used herein, an “intent” in an enriched graph may refer to at least a portion of the information and structure associated with the enriched graph, such as a node in the graph and one or more of its relationships. For the query “big apple taxis,” an enriched graph may contain the intents: the n-gram (big) matches with the intent <size=big>, the n-gram (apple) matches with the intents <fruit=apple> and <brand=Apple>, the n-gram (taxis) matches with the intent <car type=taxi>, and the n-gram (big apple) matches with the intent <city=New York>. In this example, “size” and “brand” may be represented by Attribute nodes in an enriched graph, “fruit” may be represented by a Product Type node in the enriched graph, and “city” may be represented by a Geographic node in the enriched graph. In particular embodiments, the n-grams (apple taxis), (big taxis), and (big apple taxis) may not match with any intents in the enriched graph.

After identifying which n-grams are present in the enriched graph, the intent marketplace may analyze the various combinations of these intents to determine the consumer intent, i.e., the intent of the query. As an example and not by way of limitation, for the query “big apple taxis,” the intent marketplace may determine the following possible consumer intent combinations: <size=big, fruit=apple, car type=taxi> or <city=New York, car type=taxi>. The intent marketplace may then determine which possible combination of consumer intents is most likely, which is called the primary intent, and which possible combinations of consumer intents are less likely, which are called secondary intents, to match with the actual consumer intent of the search query. There may be one or more secondary intents, and they may or may not be rank ordered based on likelihood. As an example and not by way of limitation, for the query “big apple taxis,” the intent marketplace may determine that the consumer intent combination <city=New York, car type=taxi> is a more likely and is therefore the primary intent and that the consumer intent combination <size=big, fruit=apple, car type=taxi> is less likely and is therefore a secondary intent. Once the most likely consumer intent combinations are determined, the intent marketplace may then match lines (i.e., advertising criteria, such as the target audience of, specific products of, or targeting criteria, for a particular advertiser with the consumer intent combinations. Lines that match primary intent combinations may be given priority over lines that match secondary intent combinations. Although this disclosure describes deriving consumer intent from search queries in a particular manner, this disclosure contemplates deriving consumer intent from search queries in any suitable manner. Moreover, although this disclosure describes deriving particular consumer intents from particular search queries, this disclosure contemplates deriving any suitable consumer intents from any suitable search queries.

In particular embodiments, the intent marketplace may derive consumer intents from user information associated with a user. As discussed above, the intent marketplace may derive consumer intents from search queries from a user. Furthermore, the intent marketplace may derive consumer intent from explicit or implicit user information. As an example and not by way of limitation, if the intent marketplace knows the user's present location is 1001 East Hillsdale Blvd, Foster City, Calif., then the intent marketplace may be able to determine the following possible consumer intents: <city=Foster City>, <county=San Mateo>, <state=California>, <country=United States>, <continent=North America>. In particular embodiments, search queries may be used in conjunction with other explicit or implicit user information to determine the consumer intent associated with a user's search query. As an example and not by way of limitation, for the query “apple hiring,” the possible consumer intents may be <fruit=apple>, <employer=Apple>, <call to action=hiring>, and the possible consumer intent combinations may be <fruit=apple, call to action=hiring> and <employer=Apple, call to action=hiring>. For a user with a present location of <county=San Mateo, state=California>, the <employer=Apple, call to action=hiring> may be a more likely consumer intent combination because the company Apple, Inc. is headquartered in Santa Clara County, Calif., which is adjacent to San Mateo County. In contrast, for a user with a present location of <county=Chelan, state=Washington>, the <fruit=apple, call to action=hiring> may be a more likely consumer intent combination because apple farming is a major industry in Chelan County, Wash. Although this disclosure describes deriving particular intents from particular user information, this disclosure contemplates deriving any suitable intents from any suitable user information. Moreover, although this disclosure describes deriving consumer intent from user information in a particular manner, this disclosure contemplates deriving consumer intent from user information in any suitable manner.

In particular embodiments, the intent marketplace may derive one or more consumer intents of a user visiting an advertising publisher's webpage or website by analyzing a webpage or website associated with an advertising publisher to determine an intent associated with the user. As an example and not by way of limitation, the intent marketplace may derive consumer intents by crawling a publisher's website or a particular webpage within a publisher's website to identify n-grams. An advertiser's website may be crawled in advance (pre-crawling) or in real-time (such as for dynamic webpages). A visitor to a publisher's website may have their consumer intent derived at least in part based on the content of the publisher's website. The intent marketplace may crawl an advertiser's website, identify all the words or terms on the website, and construct a set of n-grams for the website. The intent marketplace may crawl an advertiser's website at any suitable time, such as, for example, times specified by the advertiser, times specified by the intent marketplace, periodically, when the website has been modified, at another suitable time, or at two or more such times. The intent marketplace may then determine, based on the constructed n-grams, which intents from an enriched graph are present in the advertiser's website. The intent marketplace may prune or aggregate n-grams to a canonical of a set of intents (such that synonyms and misspellings, for example, are counted as the canonical) in the enriched graph to determine the frequency of the canonicals in the website. The intent marketplace may then select one or more intents that appear on a particular website and define those intents to be consumer intents associated with the website. Visitors to that website (or a webpage within that website) may then be assumed to have a consumer intent matching the consumer intent derived by the intent marketplace. Advertiser lines that match the consumer intent may then be presented to the visitor. The publisher may receive the ad, or the ad may be served directly to the visitor's client system or browser. The publisher may have specified the type of ad that should be served (such as, for example, text, display, mobile), the size of ad that should be served, and the number of ads needed. In particular embodiments, the intent marketplace may tag or label each page or section of the publisher's website with the derived consumer intents. The URL and the derived consumer intents may be cached for use when another user visits the same website or webpage. Although this disclosure describes deriving consumer intent from a publisher's website in a particular manner, this disclosure contemplates deriving consumer intent from a publisher's website in any suitable manner.

As described in the examples above, an enriched graph may be used to effectively determine a user's (i.e., consumer's) intent, for example based on query intent derived from search queries entered by a user; from any suitable detectable actions of the user, such as interactions with websites and software applications; or from any suitable combination thereof. For example, non-query intent may be detected even when a user has not entered a search query or other text, but yet the user still evidences one or more intents or interests, for example by navigating through the breadcrumb of a recommendation application such as Yelp, interacting with a social networking system, looking at product page on Amazon, looking at a retailer's website, using navigation apps, etc. As an example of determining non-query intent, a user may be viewing recommendations for a “breakfast place in Palo Alto, Calif.” on a recommendation application or website. The user's intent may be determined from the content on the webpage or application is viewing, such “breakfast” and “Palo Alto, Calif.” The content may be compared to information in the enriched graph, such as in the examples described herein, and the user intent, along with alternative expressions for and products related to that intent, may be determined. Thus, the information and relationships in an enriched graph may translate between a user's non-query actions and the corresponding search query that a user would enter to express the same or similar intent. In particular embodiments, advertisers may bid differently on query intent and non-query intent by, for example, paying different prices for those two types of intents or conducting different campaigns for those two types of intents. As described more fully herein, an enriched graph may be used to automate the building, managing, and targeting of ads in an ad campaign.

In particular embodiments, determining a user's intent may include accessing user information associated with a user. User information may include, for example, explicit user information associated with the user or implicit user information associated with the user. Explicit user information associated with a user may include present online activities of the user (e.g., current browser activities, a search query submitted by the user), past online activities of the user (e.g., browser history, websites visited), present offline activities of the user (e.g., offline purchase activity, checking-in at a venue, going out to eat, visiting a new location, life events such as moving home, changing jobs, getting married), past offline activities of the user (e.g., offline purchase history, lifecycle history, repeated activities such as regular travel to a particular location or visits to certain types of restaurants), demographic information of the user (e.g., age, income, race, ethnicity, gender, citizenship, family status, education, profession), contact information or physical location (e.g., home or work address, email address, telephone numbers), personal interests or hobbies, social-networking information of the user, client devices used (e.g., brand, model, hardware, software), services or products purchased in the past, advertisements or landing pages responded to in the past (e.g., advertisements clicked on or forms submitted via the landing pages), or other suitable information associated with the user. Implicit user information associated with a user may include a present location of a device associated with the user (e.g., current GPS coordinates of the user's smartphone, an IP address of the user's client system), a past location of a device associated with the user (e.g., past GPS coordinates of the user's smartphone, a past IP address of the user's client system), a past time when a device associated with the user was at a past location, network connection status (e.g., service provider, connection speed or bandwidth), or other suitable information associated with the user. Although this disclosure describes accessing particular types of user information associated with a user, this disclosure contemplates accessing any suitable type of user information associated with a user.

User information may be obtained from various sources. As an example and not by way of limitation, when a visitor visits a publisher's webpage, the publisher, an advertiser through an agreement with the publisher, or an ad server serving one or more advertisements onto the webpage may set cookies in the visitor's browser. These cookies may record various types of information concerning the visitor, the visitor's device, or the visitor's online activities. The information stored in the cookies may be extracted and saved. A digital-marketing system, such as the example system of FIG. 1, may have access to the information directly or may acquire the information from a third party. The digital-marketing system may then incorporate the information as needed to derive consumer intent. Although this disclosure describes obtaining user information in a particular manner, this disclosure contemplates obtaining user information in any suitable manner.

While this disclosure describes specific examples of consumer intents, determining consumer intents, and determining user information, this disclosure contemplates any suitable consumer intents, any suitable way of determining consumer intents, and any suitable way of determining user information. For example, any of the methods and systems described by U.S. Patent Application Publication No. 2012/0059713 A1, incorporated by reference in its entirety herein, may be used to determine consumer intents, determine user information, match consumer intents to information in an enriched graph (a portion of which may be known as an “intent map”), or any suitable combination thereof. Moreover, any of the system and methods, in whole or in part, disclosed by that application may be used by or in conjunction with any of the systems and methods described herein, when appropriate.

As described more fully herein, a knowledge base such as an enriched graph may be used to create effective advertising campaigns by matching products and advertisements to consumer's interests and preferences. For example, an enriched graph and, in particular embodiments, its relationships with an advertiser's catalog may be used to generate targeted advertisements, one or more libraries of targeting criteria such as keywords and ad groups, or any other suitable element of an ad campaign. In particular embodiments, such elements may be generated automatically, manually, or any suitable combination thereof.

FIG. 6 illustrates an example method 600 for managing targeted advertising strategies in connection with an example enriched graph. Method 600 may begin at step 605, where one or more ad libraries are accessed. Ad libraries may contain any suitable elements for creating and targeting ad copy, such as, for example: targeting criteria, such as keywords, products sharing similar characteristics; consumer information and characteristics; collections of phrases commonly entered by consumers; or any suitable combination thereof. In particular embodiments, an ad library may include or have access to an advertiser's catalog, an enriched graph, or any suitable combination thereof. In particular embodiments, an ad library may be edited based on analysis of past ad performance, analysis of relevant ad-related content, or any other suitable criteria.

In particular embodiments, step 606 may generate natural language recommendations for elements of an ad library to facilitate ad copy suggestions. In particular embodiments, step 606 may access information such as a user search query, data obtained from a website, and/or information in an enriched graph to suggest elements for an ad library. For example, phrases that a consumer may be interested in, such as marketing phrases and purchasing phrases, may be included in an ad library, either as entire phrases or as related combinations of the words making up those phrases. In particular embodiments, a phrase or sentence may be parsed according to one or more syntactic rules. For example, in particular embodiments a sentence or phrase may be parsed into parts of speech, such as verbs, nouns, modifiers (such as adjectives and adverbs), and subphrases such as prepositional phrases, noun phrases, and verb phrases. Natural language recommendations may be based around those syntactic rules. For example, ad-message phrases may be recommended according to particular syntactic structures, such verb phrases, noun phrases, pre- or post-modified noun phrases, or any suitable combination thereof. In particular embodiments, a word phrase may be parsed into n-grams of any suitable number or size, for example by using any of the suitable techniques described above. Moreover, any of the techniques described herein for parsing, analysing, and generating natural language may be used in any suitable method or by any suitable system described herein. For example, query intent may be determined based at least in part on techniques for parsing, and analysing natural language search queries.

In particular embodiments, step 607 may analyze competitor ads and recommend additions, deletions, or edits to an ad library. For example, competitor ads may be identified and parsed to determine ad strategies used by competitors and the ad elements used for those ad strategies. For example, for an ad library describing a high-end clothing vertical, ads in that relevant vertical may be analyzed and keywords, marketing phrases, or particular syntax (such as the number of product attributes to use in an ad copy) of those ads may be identified and added to the ad library. In particular embodiments, competitor ads may be analyzed for misspellings, length, and grammar, and may be scored accordingly. For example, competitor ads using incorrect grammar or containing misspellings may be ignored. In particular embodiments, competitor ads may be parsed using, for example, any of the natural language techniques described herein. In particular embodiments, parsed competitor ads may be compared to relevant information in an enriched graph to infer the ad strategy of the competitor ad. For example, comparison of terms in competitor ads with the contents of an enriched graph may find that when an ad uses <brand=Gucci or Coach>, as determined by parsing the ad and comparing the parsed elements to existing Attribute nodes in the enriched graph, the ad is often accompanied by marketing phrases such as “high-end,” “luxurious,” and/or “stylish.” As another example, analysis of competitor ads with the enriched graph may find that when an ad uses <condition=refurbished> then the ads are likely to include marketing phrases such as “inexpensive,” “on sale,” or the like. As the number of competitor ads analyzed increases, one or more ad strategies may be determined and recommend for inclusion in an ad library.

In particular embodiments, an ad library may include one or more keyword templates. In particular embodiments, keyword templates may be stored in, created from, or accessed from any suitable data or data structure. A keyword template may comprise information associated with one or more nodes and its relationships in an enriched graph. In particular embodiments, a keyword template may be derived from an advertiser's existing ad copy or ad campaigns. In particular embodiments, a keyword template may be constructed using keywords, expressions, placeholders or variable names (such as, for example, intent topics, intents, or key intents) from parts of the enriched graph. This may be done in a partially- or fully-automated manner using the enriched graph and various data sources. Data sources may include, for example, keyword lists, query logs, product catalogs, guided navigation facets, historical performance data from marketing campaigns, website content, other suitable data sources, or two or more such sources. In particular embodiments, a keyword template may be constructed based at least in part on a collection of known keywords. As an example and not by way of limitation, a keyword generator may analyze a collection of known keywords, such as a keyword list. The keyword generator may then select, from the collection of known keywords, one or more of the known keywords that are applicable to the enriched graph. The keyword generator may then construct a keyword template based on one or more of the selected known keywords. In particular embodiments, a keyword template may be constructed based at least in part on the historical performance of particular keywords. As an example and not by way of limitation, when selecting keywords that are applicable to an enriched graph for a plurality of products as part of constructing a keyword template, a keyword generator may select, from a collection of known keywords, one or more specific known keywords that are related to the plurality of products. The keyword generator may then analyze historical performance information of the specific known keywords that are related to the plurality of products. Then, to construct the keyword template, the keyword generator may select from the specific known keywords one or more known keywords that have a relatively higher performance with respect to one or more predetermined metrics (such as, for example, impression volume, click volume, conversion volume, click-through-rate, conversion rate, etc.). In particular embodiments, a keyword template may be constructed based at least in part on the intents associated with particular segments of particular keywords. As an example and not by way of limitation, when constructing a keyword template based on known keywords, a keyword generator may, for each known keyword, divide the known keyword into one or more segments. The keyword generator may then, for each segment, identify an intent from the enriched graph that aligns with the segment and then replace the segment with a node from the enriched graph to which the intent belongs. In particular embodiments, a keyword template may be constructed based at least in part on one or more rules. As an example and not by way of limitation, an advertiser may then apply business rules to have the keyword generator combine templates with words/relationships in the enriched graph to generate highly relevant keywords at scale. In particular embodiments, one or more of the rules for constructing a keyword template may be based on one or more nodes from the enriched graph. As an example and not by way of limitation, the generated keywords may be tagged with the enriched graph relationships/intents of the words contained within the keyword when generating a keyword template. As another example and not by way of limitation, if one or more of the nodes form a hierarchy in the enriched graph, then one or more of the keyword templates may be constructed based on the hierarchy. In addition, the keyword generator may automatically query online traffic estimation tools (such as, for example, Google's AdWords Traffic Estimator) to determine the traffic volume that a generated keyword might expect. Keywords or keyword templates whose estimated traffic volume falls below some threshold may be discarded by the keyword generator. Although this disclosure describes constructing keyword templates in a particular manner, this disclosure contemplates constructing keyword templates in any suitable manner.

In particular embodiments, a keyword template may generate a very large number of keywords. Thus, in particular embodiments, a subset of relevant keywords may be selected from the universe of possible keywords by pruning keyword templates and/or filtering keywords. For example, in particular embodiments, a keyword template may comprise <Brand><Attribute><Product>, with each topic in the template corresponding to a type or kind of node in an enriched graph. A keyword template may be used to generate keyword expressions, which may comprise combinations of the subtopics, or child nodes, in accordance with the structure and substance of the keyword template. For example <Brand><Attribute><Product> may generate keyword expressions such as <Brand><Color><Product>, <Brand><Size><Product>, <Brand><Material><Product>, or any other possible combination as indicated by the nodes in and structure of a corresponding enriched graph. Each keyword expression can then be used to generate one or more keywords or keyword phrases, for example by inserting the specific concepts corresponding to specific nodes in an enriched graph into the appropriate placeholder in the keyword expression. For example, the keyword expression <Brand><Color><Product> may generate keyword phrases such as “Coach Black Handbag,” “Coach Red Handbag,” “Coach Brown Wallet,” and the like. This disclosure contemplates any suitable keyword templates generating any suitable keyword expressions generating any suitable keywords or keyword phrases.

As an enriched graph may include a very detailed set of nodes and relationships between nodes to describe a vertical, the number of keywords generated from a keyword template may be impractically large. Keyword pruning may be used to generate a more useable and useful subset of keywords. For example, keyword expressions, keywords, or both may be scored based on the similarity between the expression or keyword and the language (e.g., the words and grammatical structure) used in an advertiser's product catalog. As an example, phrases in an advertiser's product catalog, such as “Weber Premium Gas Grill Cover,” may be parsed into n-grams, and the resulting n-grams may be compared to the corresponding nodes in the enriched graph. The parsed information may then be generalized from the information in the enriched graph, i.e., “Weber Premium Gas Grill Cover” may map at least to <Brand><Attribute><Power Type><Product><Accessory> in the enriched graph. Thus, keyword expressions may likewise be generalized (if not in that form already) and scored based on their similarity to the structure and content in the generalized listing from the advertiser's product catalog. Scoring may be performed by any suitable algorithm or model. Keyword expressions may then be selected by any suitable metric, for example by selecting only those keyword expressions that score in the top 5%. In particular embodiments, keywords may be pruned by selecting the keywords that have the highest consumer interest associated with them, determined, for example by the search-query volumes associated with those keywords or keyword phrases. In particular embodiments, keywords may be pruned by selecting the keywords that have the highest value associated with them, as determined by any suitable metric such as cost per click, revenue per click, etc. Particular embodiments may use more than one pruning method described above to reduce the volume of keywords generated by keyword templates, yet still include the most relevant keywords in an advertiser's campaign.

In particular embodiments, step 608 may generate flexible syntactic ad templates for use by an ad library. For example, ad templates may be predetermined structures for generating grammatically correct ads that must meet variable length constraints. For example, an ad may comprise a set of ad messages, or word phrases, for display. Each ad message may include optional text elements and/or required text elements, collectively referred to as “ad elements.” For example, optional ad elements may correspond to one or more Attribute nodes in an enriched graph, and required elements may correspond to a Product node in an enriched graph. The structure of a flexible syntactic ad template ensures that an ad message is grammatically correct even if one or more of the optional ad elements are removed from the sentence.

Flexible syntactic ad template 710 of FIG. 7 illustrates an example flexible syntactic ad template. As illustrated, the flexible syntactic ad template comprises a template for an ad message composed of ad elements, which may correspond to nodes or other information in an enriched graph. In the example of flexible syntactic ad template 710, optional elements may be <color> and <material>, and required elements may be <product>. Flexible syntactic template 710 contains an ad element corresponding to marketing phrases or purchasing intents (which may be used interchangeably, where appropriate). Flexible syntactic ad template 710 provides a specific structure for an ad message, and its syntax, i.e., the number and order of ad elements comprising the ad message. If either of the optional ad elements of flexible syntactic ad template 710 is removed, the ad message is still grammatically correct. As described more fully herein, in particular embodiments, the order, number, or type of ad elements in a flexible syntactic ad template may be adjusted by an advertiser, may be automatically determined (e.g., based on analysis of competitor ads or past ad performance), or any suitable combination thereof. In particular embodiments, keyword templates and flexible syntactic ad templates may be related to each other based on the shared nodes in an enriched graph that each template refers to. For example, a keyword template may be <Attribute><Product>, while a flexible syntactic ad template may include <Brand><Attribute><Product> in a generalized ad message. Thus, the generalized ad message in the flexible syntactic ad template could, in particular embodiments, be a more detailed description of the nodes and edges encompassed by a keyword template, for example by including appropriate Brand nodes with the portion of the enriched graph the keyword template maps to. In particular embodiments, a flexible syntactic ad template may include one or more keyword templates in one or more ad messages.

At step 610, a user (e.g., an advertiser) may determine ad strategies for all or a portion of its catalog of products. In particular embodiments, the advertiser is provided with a user interface (“UI”) for turning its ad strategies into targeted ad campaigns, ad groups, and ad copies. FIGS. 8-13 illustrate example UIs for generating and monitoring ad strategies. In particular embodiments, the software presenting the UI may interface with an enriched graph, thus providing all of the information discussed herein for use in creating and monitoring ad campaigns.

FIGS. 8A-B illustrate an example UI for selecting products, attributes, and related information for inclusion in targeted advertising. UIs 8A-B may include a menu 810 describing the options that are available to an advertiser, such as, for example, ad performance tools, ad recommendations, ad groups, keyword groups, and the like. UIs 8A-B may include one or more status bars 815 that describe, for example, the breadcrumb corresponding to portion the advertiser's catalog that the advertiser is currently working with in the UI, the ad groups that are not currently associated with any live ad, and the number of terms (either taken from the advertiser's catalog or from an enriched graph corresponding to the advertiser's catalog) that are not used in any advertisement.

UIs 8A-B may include an element 820 that allows an advertiser to select the products and corresponding attributes that the advertiser wishes to build its an ad campaign, ad group, or specific advertisement around. In particular embodiments, the products and corresponding attributes may be organized according the advertiser's own catalog, using the terms and descriptions that the advertiser is most familiar with. In particular embodiments, products and corresponding attributes may be organized according to the structure of an enriched graph corresponding to the advertiser's catalog. For example, in particular embodiments, the products and attributes available for the advertiser to select from may include Product nodes and Attribute nodes that are present in the advertiser's enriched graph, and the corresponding values for the attributes and products may be Attribute Value nodes that are connected to the relevant Product and Attribute nodes. For example, an advertiser may select from brands 830, products 840, usage-related attributes 870, and demographic-targeting data 880. In particular embodiments, as, illustrated in FIGS. 8A-B, an advertiser may select one or more of each topic to include in an advertising campaign or in potential ad copies. In particular embodiments, a user may add additional topics to the list of topics available for inclusion in an advertising campaign, such as, for example, by selecting “Add More Topics” interactive element 890, or by selecting an empty UI element 860. Topics for addition may be identified from an advertiser's catalog, from an enriched graph corresponding to an advertiser's catalog, or any suitable combination thereof. For example, each of the topics listed in UI element 850 may correspond to a product, description, or other suitable advertising topic in the advertiser's catalog, or may correspond to one or more nodes or relationships in an enriched graph corresponding to the advertiser's catalog. In particular embodiments, topics may be given the labels that correspond to those in the advertiser's catalog, but the available terms within the topics may be enriched with information from an enriched graph corresponding to the advertiser's catalog. In particular embodiments, an advertiser may freely type text into UI elements 830, 840, 870, or 880, and the advertiser's catalog or enriched graph may be searched for content corresponding to the typed text. In particular embodiments, if the advertiser enters text that is not found in either the catalog or the enriched graph, the advertiser's catalog and/or the enriched graph may be updated to include the typed text. In particular embodiments, UI element 820 displays those topics and terms for creating targeted advertisement that have been selected by an advertiser, as illustrated in FIG. 8B.

In particular embodiments, the UI can provide one or more formats for all or some of the ad copy of an advertisement, and the advertiser may select one of the formats for the ads being targeted corresponding to the ad campaign. As an example, the formats may be presented according to one or more flexible syntactic ad templates described above, according to one or more advertiser-selected preferences, according to ad performance metrics, according to competitor ad and/or natural language analysis, or any suitable combination thereof. After an advertiser has selected one or more formats for the ad copy, the UI may present UI elements that allow the advertiser to select the specific or general content of the ad copy. In addition or the alternative, in particular embodiments an advertiser may be able to rearrange the format of the ad copy template that was selected. For example, FIG. 9A illustrates a selected template 905. Template 905 displays the organization and content categories available to the advertiser. In particular embodiments, template 905 displays: 1) the minimum ad length required to comply with publisher settings; and 2) the content corresponding to the general categories displayed by the ad template. UI elements 910-960 of FIGS. 9A-B allow an advertiser to select specific content corresponding to the general categories specified by template 905. In particular embodiments, the specific content may correspond to content in the advertiser's catalog or to content in an enriched graph corresponding to the advertiser's catalog. In particular embodiments, an advertiser may add or remove additional categories of content to an advertising template, such as for example by using UI element 970.

In particular embodiments UI element 980 illustrates the specific structure an ad message will have based on the template, the general content categories, and the ordering of those categories selected by the advertiser. In particular embodiments, the advertiser may edit the structure and content of generated ad copy by directly editing UI element 980. In particular embodiments, UI element 990 displays a real-time preview of one or more fully-formed advertisements using the general content specified by element 905, the specific ad copy content specified by elements 910-960, the content corresponding to that specific content in the advertiser's enriched graph, and the structure and format presented in element 980. In particular embodiments, the advertiser may preview additional advertisements, for example by scrolling element 990 left or right.

The preview of fully-formed ads in element 990 may correspond to method step 615, where ad copy is generated based on the user's ad strategies and the contents of the ad library. In particular embodiments, ad copy may be generated through the use of ad optimization logic 700. For example, ad optimization may receive content, such as the general content specified by element 905, the specific ad copy content specified by elements 910-960, the content corresponding to that specific content in the advertiser's enriched graph, the structure and format for ads presented in element 980, or any suitable combination thereof, and filter the content based on length considerations, relevance, importance of ad elements, past performance, potential bidding prices, or any other suitable metric. As an example, publishers may only publish ads with minimum or maximum lengths, and the optimizer may enforce those requirements. For example, the optimizer may remove one or more optional ad elements, such as color, from the ad copy. As another example, the optimizer may attempt to select ad elements shorter than, but still roughly synonymous with, those in the ad copy it receives. Synonymous ad elements may be determined from the information in an advertiser's enriched graph. In particular embodiments, the optimizer may optimize for relevance, for example based on a query or non-query intent for which the advertiser is currently or about to bid on, based on the characteristics of consumers that have illustrated the targeted intent, based on analysis of past performance of advertisements and specific ad copy, or any other suitable relevance metric. In particular embodiments, an optimizer may use rules of grammar and syntax to rearrange ad elements into the most grammatically correct form. For example, an optimizer may utilize structures such as modified noun phrases (including pre-modifiers and post-modifiers), verb phrases, adjective phrases, or any other suitable syntactic rule or expression to arrange ad elements in ad copy. As another example, the optimizer may analyze natural language queries or competitor ads (or both) to determine the “best” order for ad elements in an ad copy. In this example, “best” may be determined through any suitable algorithm, for example the number of times a particular order appears in query or competitor ad, the number of times that particular order appears in the advertiser's catalog, etc. In particular embodiments, the optimizer may determine the order in which ad elements appear by finding the ad element, or its equivalent, in the enriched graph for the advertiser and determining what the ad element corresponds to, i.e., whether it is an adjective, a color, specific brand, etc. FIG. 7 illustrates an example optimizer 700 that receives input in the form of keywords 705 and a flexible syntactic ad template 710 to create optimized candidates for ad copy 715.

As described in the examples above, providing an advertiser with a user interface that can draw content from the advertiser's catalog, the advertiser's enriched graph, information about consumer intents, information about past ad performance, and any other suitable ad targeting information removes much of the manual labor associated with managing ad campaigns, ad groups, targeting criteria, and creating ad copy. For example, when the UI described above is interfaced with an advertiser's enriched graph, the advertiser need not think of all synonyms, antonyms, and alternative descriptions of the products in its catalog in order to properly target consumers who signify their intent using those synonyms, antonyms, and alternative descriptions. And because intent can be more accurately determined based on an enriched graph, the advertiser can more easily determine who its target consumers actually are. As described above, various portions of the process of generating advertisements, selecting targeting criteria (such as terms that can be used as keywords), determining the structure of advertisements, optimizing advertisements, and generating the optimized, targeted advertisements can be partially or fully automated, substantially reducing the burden on the advertiser and providing much richer targeted advertisements in real-time than the advertiser is likely to have the resources to do on its own. Moreover, the selection process may be presented according to the format and descriptions used by the advertiser's own catalog, thus providing a familiar interface to an ad targeting platform.

In particular embodiments, all or some of the inputs described herein may be used to automate creation of ad campaigns without requiring almost any advertiser input. For example, data about an advertiser's products may be automatically acquired using any of the suitable methods described herein, such as automatically crawling an advertiser's website or automatically generating a product feed for the advertiser. Of course, an ad campaign may also be created if the advertiser supplies some or all of such information. As described more fully above, an advertiser's data may be enriched with information from an enriched graph, which automatically provides the advertiser with a number of targeting criteria, such as keywords based on alternate descriptions of products in the advertiser's catalog or similar products as determined by semantic meanings from the enriched graph. Moreover, data from the ad library discussed in connection with FIG. 6 may be used to automatically generate the targeting criteria, such as keywords, and the adcopy necessary to target consumer and deliver ads to publishers and bidding exchanges, for example by using an advertiser's existing keyword campaign; logs of consumer intent, such as search queries; and analysis of competitor ads. Interfacing the enriched graph with the ad library provides more refined targeting criteria and adcopy, as described more fully herein.

Thus, in particular embodiments, an advertising campaign may be automatically generated by: 1) automatically uploading an advertiser's information into a knowledge base; 2) automatically enriching the advertiser's information with information in an enriched graph; 3) automatically generating and grouping targeting criteria, such as keywords or product listings, based on information contained in an ad library and/or the enriched graph; and 4) automatically generating ad copy based on the advertiser's enriched product information, the targeting criteria, consumer intents, and/or templates (such as keywords templates or flexible syntactic advertising templates) stored in the ad library. Any of those steps may be performed using any of the suitable methods and system described herein. In particular embodiments, ad performance and bidding may also be automated, as described more fully herein. In particular embodiments, any of the steps described above may be supplemented with, or replaced by, manual intervention.

While the above examples described targeting and ad generation in terms of content that would seemingly correspond to keyword campaigns, the systems and methods described above apply equally well to product-based campaigns, where the targeting is based not on keywords associated with consumer-entered text but on the relevance of an advertiser's product itself to the user's query or non-query intent. For example, a consumer's search query may be mapped, for example by using the information in an enriched advertiser-specific graph, to the products and product attributes most relevant to the consumer. Ad copy for the relevant products may then contain the product descriptions and attributes most relevant to the user's query. As an example of creating a product-based campaign, FIGS. 11A-B illustrate an example UI that allows an advertiser to select specific products, rather than terms, from its own catalog to target to consumers. Element 1115 allows an advertiser to add products selectively or collectively to its ad campaigns. UI may display the advertiser's catalog according the structure and taxonomy of that catalog, for example by using categories 1115A-C and specific products 1120. The advertiser can select the products in its catalog that it wants to add to a specific campaign or ad group. FIG. 12 illustrates an alternative interface that allows an advertiser to select and filter products from its catalog. Once an advertiser has selected the products it wants to add to a campaign, the advertiser can proceed to build its ad structure for that campaign, for example by using the Ad Structure Boards 1315 of FIG. 13A. As described above, the advertiser can rearrange, add to, remove, and edit elements of Ad Structure Board 1315 to customize its advertisements. Element 1305 may inform an advertiser where in the automated process the advertiser is, and how much it has left to do to complete to build its campaign.

In particular embodiments, once an advertiser has added products to an ad campaign, the advertiser can create ad groups by organizing products based on advertiser-selected characteristics, such as those illustrated by example elements 1320A-D of FIG. 13B. In particular embodiments, characteristics may include shared descriptions from the advertiser's product catalog or shared nodes in an enriched graph. For example, the advertiser may group products based on shared Attribute nodes in an enriched graph (such as brand, material, etc.), based on consumer information such as gender, or any other suitable characteristic or combination of characteristics. As illustrated in FIG. 13C, an advertiser can select particular characteristics such as specific brands 1325, for grouping in an ad campaign.

In particular embodiments, an advertiser using the UI and backend described above can create both a keyword campaign and a product-based campaign. Because the advertiser's enriched graph identifies the advertiser's products, identifies relationships with other products, and identifies the relationships necessary to describe those products and related products using words, the enriched graph contains all the information necessary to generate product-based and keyword campaigns. In particular embodiments, an advertiser may select the products, keywords, or any combination thereof that it would like to target and the relationships in the enriched graph will create corresponding keyword and product-based advertising campaigns. In other words, in this embodiment, the advertiser would no longer have to manage two separate campaigns to advertise the same products on different advertising platforms.

After an ad copy is generated in step 615, the advertiser may bid on one or more ad spaces, as described more fully herein. In particular embodiments, each bid may comprise an advertiser intent, an advertisement, a condition, and a maximum payment amount that an advertiser placing the bid agrees to pay when the condition is satisfied. As an example and not by way of limitation, a combination of intent topics that an advertiser may bid on may be <shoes>, or <brand><shoes>, or <color><brand><shoes>. The line (i.e., advertising criteria) may be constrained to certain advertiser intents. As an example and not by way of limitation, a line may be constrained to specific brands with the construction <brand=Nike, Adidas, Reebok><shoes>. Similarly, certain advertiser intents may be excluded from lines. As an example and not by way of limitation, a line may exclude a certain brand with the construction <brand !=Puma>. The sequence of intent topics in a line may or may not have significance, such that a particular ordering of intent topics may be significant in particular embodiments. In particular embodiments, the advertiser may specify that the line should exclude particular intent topics. As an example and not by way of limitation, for the line <brand><shoes>, the query “green Nike shoes” could be excluded because it includes the user intent <color=green>, and the <color> intent topic is not included in the line. In this case, the query would not be matched with the line <brand><shoes> because it includes an intent outside of the scope of the intents specified in the line. In particular embodiments, an advertiser may choose to specify the channel associated with a line, such as, for example, paid search, mobile, display, another suitable channel, or two or more such channels. If the channel specified is display, the advertiser may also specify the size of the banner ad. For each associated channel, a line may have one or more ads associated with the line. For paid search, a paid search text ad may include, for example a headline/title, one or more lines of ad description, a display URL, and a click-through URL. For a display ad, the ad may include, for example, a banner ad and a click-through URL. Multiple banner ads may be associated with a display line since there are multiple sizes for banner ads. For a mobile ad, the ad may include, for example, a mobile ad and a click-through URL. Ads may be stored as separate entities from the line, so that any line may be associated with any ad that is suitable for a particular channel. The intent marketplace may include an ad creation tool that enables an advertiser to create intent-based ad templates. An ad template may be associated with a line if the intent topics contained in the line are also contained in the template. In particular embodiments, an advertiser may choose to specify one or more publishers associated with a line, such as, for example, by selecting from a list of publishers in the system. There may be some publishers that participate on a blind/anonymous basis, and other publishers that participate on a non-blind basis. Although this disclosure describes an intent marketplace receiving bids in a particular manner, this disclosure contemplates an intent marketplace receiving bids in any suitable manner.

In particular embodiments, an advertiser may utilize a bid-management system to improve and facilitate the bidding process. For example, a bid-management system may recommend bids on targeting criteria, such as keywords, and/or may recommend changes to bidding strategies. A bid-management system may analyze and recommend bids based on any suitable metric, such as cost per click, revenue per click, cost per view, or the like.

An example bid management system may pull data about one or more advertiser's ad campaigns, for example from a publisher or from an advertiser. The data pulled may include any relevant information such as date, targeting criteria used in the advertisement, impressions, clicks, bids, quality score, conversions, cost, revenue, or any other suitable information. Once data is pulled, a bid-management system may estimate a bidding metric, such as revenue per click, for each targeting criteria being evaluated. In particular embodiments, only targeting criteria that has a non-zero value related to the bidding metric of interest may be used. For example, if revenue per click is being estimated, only keywords with 1 or more clicks may be used to estimate revenue per click. A bidding metric may be estimated using any suitable algorithm or model, such as, for example, a least squares regression model, a logistic regression model, a linear model, a quadratic model, a log linear mixed model, based on interpolation of historical bidding information, or any suitable combination thereof. Any suitable information may be used as an input to the model or algorithm, such as, for example: percentile ranking of the targeting criteria based on, e.g., click count; temporal information such as day of the week; match type (e.g., how well the targeting criteria match the consumer intent); or any suitable combination thereof. Once the bidding metric is estimated, optimal bids or adjustments to bid strategy may be made based on any suitable algorithm or model. The bid-management system may normalize the estimated bids (e.g., by reducing large recommended changes, by ignoring very small recommended changes and instead retaining the original bid amount, etc.) and may publish the bids to a publisher. In particular embodiments, before publishing bids a bid management system may select one or more recommended bids or changes to bid strategy for manual review.

In particular embodiments, method 600 may generate reports describing the performance of the advertiser's ads and ad strategies. FIGS. 10A-B illustrate an example UI for reporting ad performance. As illustrated by element 1005, in particular embodiments the UI may display information such as the number of ad groups, terms, or both that are not covered by any current advertisement for the advertiser. As illustrated by element 1010, in particular embodiments the UI may display information such as ads generated as a function of time and the number of terms per ad. As illustrated by element 1015 and 1020, in particular embodiments the UI may display information about active and inactive templates, and provide the user an interface 1025 for adding new templates. In particular embodiments, the example UI elements may provide additional information such as the minimum ad length and whether the ad meets publishers' length requirements, the amount of ad coverage provided, and metrics describing ad performance, such as conversion rates, click-through rates, or any other suitable metric. A performance report may show, for example, the number of impressions, the number of clicks, the click-through-rate, the cost-per-click, the number of conversions, the conversion rate, the cost-per-action, or other suitable performance information associated with the line. The intent marketplace may also provide intent-based performance reports that allow advertisers to filter or aggregate lines based on one or more intents. As an example and not by way of limitation, a performance report may allow an advertiser to filter reports on lines to show the performance of lines with the intents <color=red> and <brand=Nike>. Performance reports for advertisers may be in aggregate, by line, by creative, or by intent combinations. Performance reports for publishers may be in aggregate, by URL, or by intent combination. In particular embodiments, performance may be reported in relation to information in an advertiser's catalog rather than in terms of a publisher's campaign structure. For example, reporting for a product-based campaign may describe performance based on products and descriptions, rather than (or in addition to) reporting based on keywords or ad groups. Although this disclosure describes an intent marketplace providing particular reports in a particular manner, this disclosure contemplates an intent marketplace that provides any suitable reports in any suitable manner.

In particular embodiments, method 600 may manage ad quality at step 625. For example, step 625 may evaluate the performance of existing ads, such as, for example click-through rates and conversion rates, and use those results to determine which ads, ad elements, ad templates, targeting criteria, consumer characteristics and intents, or any suitable combination thereof, improve ad targeting performance. Step 625 may include any of methods and systems for analyzing ads, products, and consumers described herein, where suitable. The method of FIG. 6 may end at step 625. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for automatically building and maintaining the ad campaign of FIG. 6, this disclosure contemplates any suitable method for automatically building and maintaining the ad campaign including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

FIG. 14 illustrates an example advertising platform 1402 in a network environment 1400. Network environment 1400 includes a network 1410 coupling one or more ad exchanges 110, one or more advertising platforms 1402, one or more advertising servers (ad servers) 1424, one or more web servers 1422, and one or more clients 1430 to each other. Although not shown, other types of servers may also be included in network environment 1400. For example and without limitation, network 1410 may also couple one or more news servers, mail servers, message servers, file servers, application servers, exchange servers, database servers, proxy servers, etc. to each other or to ad exchanges 1404, advertising platforms 1402, ad servers 1424, web servers 1422, or clients 1430. This disclosure contemplates any suitable network environment 1400. As an example and not by way of limitation, although this disclosure describes and illustrates a network environment 1400 that implements a client-server model, this disclosure contemplates one or more portions of a network environment 1400 being peer-to-peer, where appropriate. Particular embodiments may operate in whole or in part in one or more network environments 1400. In particular embodiments, one or more elements of network environment 1400 provide functionality described or illustrated herein. Particular embodiments include one or more portions of network environment 1400. Network environment 1400 includes a network 1410 coupling one or more ad servers 1424, one or more web servers 1422, one or more clients 1430, one or more ad exchanges 1404, and one or more advertising platforms 1402 to each other. This disclosure contemplates any suitable network 1410. As an example and not by way of limitation, one or more portions of network 1410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1410 may include one or more networks 1410.

Links 1450 couple ad servers 1424, web servers 1422, clients 1430, ad exchanges 1404, and advertising platforms 1402 to each other. This disclosure contemplates any suitable links 1450. As an example and not by way of limitation, one or more links 1450 each include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) links 1450. In particular embodiments, one or more links 1450 each includes an intranet, an extranet, a VPN, a LAN, a WLAN, a WAN, a MAN, a communications network, a satellite network, a portion of the Internet, or another link 1450 or a combination of two or more such links 1450. Links 1450 need not necessarily be the same throughout network environment 1400. One or more first links 1450 may differ in one or more respects from one or more second links 1450.

This disclosure contemplates any suitable ad server 1424 or web server 1422. As an example and not by way of limitation, one or more ad servers 1424 or web servers 1422 may each include one or more advertising servers, applications servers, catalog servers, communications servers, database servers, exchange servers, fax servers, file servers, game servers, home servers, mail servers, message servers, news servers, name or DNS servers, print servers, proxy servers, sound servers, standalone servers, web servers, or web-feed servers. In particular embodiments, an ad server 1424 or web server 1422 may include hardware, software, or both for providing the functionality of ad server 1424 or web server 1422. As an example and not by way of limitation, a web server 1422 that operates as a web server may be capable of hosting websites containing webpages or elements of webpages and include appropriate hardware, software, or both for doing so. In particular embodiments, a web server may host HTML or other suitable files or dynamically create or constitute files for webpages on request. In response to a Hyper Text Transfer Protocol (HTTP) or other request from a client 1430, the web server 1422 may communicate one or more such files to client 1430. As another example, a web server 1422 that operates as a mail server may be capable of providing e-mail services to one or more clients 1430. As another example, an ad server 1424 or web server 1422 that operates as a database server may be capable of providing an interface for interacting with one or more data stores (such as, for example, data stores 1440 described below).

In particular embodiments, each web server 1422 or each ad server 1424 may be a unitary server or may be a distributed server spanning multiple computers or multiple datacenters. In particular embodiments, each web server 1422 or each ad server 1424 may include hardware, software, or embedded logic components or a combination of two or more such components for carrying out the appropriate functionalities implemented or supported by web server 1422 or ad server 1424. For example, a web server 1422 is generally capable of hosting websites containing webpages or particular elements of webpages. More specifically, a web server 1422 may host HTML files or other file types, or may dynamically create or constitute files upon a request, and communicate them to clients 1430 in response to HTTP or other requests from clients 1430. An ad server 1424 is generally configured to place advertisements (e.g., advertisements 152 as illustrated in FIG. 1) or advertising related content in ad spaces.

In particular embodiments, one or more links 1450 may couple an ad server 1424, web server 1422, ad exchange, or advertising platform 1402 to one or more data stores 1440. A data store 1440 may store any suitable information, and the contents of a data store 1440 may be organized in any suitable manner. As an example and not by way or limitation, the contents of a data store 1440 may be stored as a dimensional, flat, hierarchical, network, object-oriented, relational, XML, or other suitable database or a combination or two or more of these. A data store 1440 (or an ad server 1424, web server 1422, ad exchange 1404, or advertising platform 1402 coupled to it) may include a database-management system or other hardware or software for managing the contents of data store 1440. The database-management system may perform read and write operations, delete or erase data, perform data deduplication, query or search the contents of data store 1440, or provide other access to data store 1440.

In particular embodiments, one or more of ad server 1424, web server 1422, ad exchange 1404, or advertising platform 1402 may each include one or more search engines. A search engine may include hardware, software, or both for providing the functionality of search engine. As an example and not by way of limitation, a search engine may implement one or more search algorithms to identify network resources in response to search queries received at search engine, one or more ranking algorithms to rank identified network resources, or one or more summarization algorithms to summarize identified network resources. In particular embodiments, a ranking algorithm implemented by a search engine may use a machine-learned ranking formula, which the ranking algorithm may obtain automatically from a set of training data constructed from pairs of search queries and selected Uniform Resource Locators (URLs), where appropriate.

In particular embodiments, one or more servers 1420 may each include one or more data monitors/collectors 1424. A data monitor/collection 1424 may include hardware, software, or both for providing the functionality of data collector/collector 1424. As an example and not by way of limitation, a data monitor/collector 1424 at a server 1420 may monitor and collect network-traffic data at server 1420 and store the network-traffic data in one or more data stores 1440. In particular embodiments, server 1420 or another device may extract pairs of search queries and selected URLs from the network-traffic data, where appropriate.

In particular embodiments, an ad server 1424 includes one or more servers or other computer systems for hosting advertisements for inclusion in webpages hosted by web servers 1422. The present disclosure contemplates any suitable ad servers 1424. Examples of ad serving platforms include, without limitation, DOUBLECLICK DART for PUBLISHERS, or GOOGLE ADSENSE. One or more ad servers 1424 may be operated by an advertiser (e.g., advertiser 150 as illustrated in FIG. 1). A webpage may include elements hosted by any combination of web servers 1422 and ad servers 1424. When a web browser at a client 1430 renders a webpage, the web browser may retrieve and load one or more elements of the webpage from one or more web servers 1422, as directed by one or more HTML or other files for rendering the webpage. The web browser may retrieve and load one or more advertisements (e.g., advertisement 152 as illustrated in FIG. 1) placed in the webpage from one or more ad servers 1424, similarly as directed by the HTML or other files for rendering the webpage.

In particular embodiments, one or more data storages 1440 may be communicatively linked to one or more severs (e.g., web servers 1422 or ad servers 1424) via one or more links 1450. In particular embodiments, data storages 1440 may be used to store various types of information or data. In particular embodiments, the data stored in data storages 1440 may be organized according to specific data structures. Particular embodiments may provide interfaces that enable servers (e.g., web servers 1422 or ad servers 1424) or clients 1430 to manage (e.g., retrieve, modify, add, or delete) the information stored in data storage 1440. In particular embodiments, data storage 1440 may have suitable types of database software, such as, for example and without limitation, ORACLE DATABASE, SYBASE SQL SERVER, or MICROSOFT SQL SERVER, which are capable of managing the data stored in data storage 1440 and enabling web servers 1422, ad servers 1424, or clients 1430 to access the stored data. The present disclosure contemplates any suitable data storage 1440.

This disclosure contemplates any suitable clients 1430. A client 1430 may enable a user at client 1430 to access or otherwise communicate with network 1410, ad server 1424, web server 1422, ad exchange 1404, advertising platform 1402, or clients 1430. As an example and not by way of limitation, a client 1430 may have a web browser, such as MICROSOFT INTERNET EXPLORER or MOZILLA FIREFOX, and may have one or more add-ons, plug-ins, or other extensions, such as GOOGLE TOOLBAR or YAHOO TOOLBAR. A client 1430 may be an electronic device including hardware, software, or both for providing the functionality of client 1430. As an example and not by way of limitation, a client 1430 may, where appropriate, be an embedded computer system, an SOC, an SBC (such as, for example, a COM or SOM), a desktop computer system, a laptop or notebook computer system, an interactive kiosk, a mainframe, a mesh of computer systems, a mobile telephone, a PDA, a netbook computer system, a server, a tablet computer system, an electronic billboard or other device capable of mass-marketing, or a combination of two or more of these. Where appropriate, a client 1430 may include one or more clients 1430; be unitary or distributed; span multiple locations; span multiple machines; span multiple datacenters; or reside in a cloud, which may include one or more cloud components in one or more networks.

A client 1430 may enable its user to communicate with other users at other clients 1430 or with web servers 1422. For example, a user (e.g., visitor 130 as illustrated in FIG. 1) at client 1430 may enter a Uniform Resource Locator (URL) or other address directing the web browser to web server 1422, and the web browser may generate a HTTP request and communicate the HTTP request to web server 1422. Web server 1422 may accept the HTTP request and communicate to client 1430 one or more HTML files responsive to the HTTP request. Client 1430 may render a webpage based on the HTML files from web server 1422 for presentation to the user. The present disclosure contemplates any suitable webpage files. As an example and not by way of limitation, webpages may render from HTML files, Extensible HyperText Markup Language (XHTML) files, or Extensible Markup Language (XML) files, according to particular needs. Such pages may also execute scripts such as, for example and not by way of limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

The present disclosure contemplates any suitable webpages. As an example and not by way of limitation, webpages hosted by web servers 1422 may be static or dynamic. In particular embodiments, multiple webpages stored together in a common directory at a web server 1422 make up a website or a portion of a website. In particular embodiments, a webpage may include one or more elements. As an example and not by way of limitation, presented (or rendered) elements of a webpage may include static text, static images, animated images, audio, video, interactive text, interactive illustrations, buttons, hyperlinks, or forms. Such elements may each occupy a particular space on the webpage when displayed. Internal (or hidden) elements of a webpage may include, for example and not by way of limitation, comments, meta elements, databases, diagramation and style information, and scripts, such as JAVASCRIPT. One or more elements of a webpage may be inline frames (IFrames), which enable web developers to embed HTML documents into other HTML documents. Herein, reference to a document may encompass a webpage, where appropriate. Reference to an element of a webpage may encompass one or more portions of a webpage file for rendering the element, and vice versa, where appropriate.

Client 1430 may execute one or more software applications of any suitable type. In addition or the alternative, applications may execute all or in part on any suitable computers in network environment 1400, and content from or related to those applications may be displayed on client 1430, or otherwise communicated to a user of client 1430. In particular embodiments, an application may include software that displays an advertisement, transmits an advertisement, or receives an advertisement.

One or more elements of a webpage or software applications may be advertisements. A position in the webpage or application where an advertisement is placed may be referred to as an ad space. In particular embodiments, an advertisement has various attributes. As an example and not by way of limitation, attributes of an advertisement may include format (such as text, image, video, audio, animation, gadget, etc.); size; webpage position (such as top, left, above the fold, below the fold, etc.); inclusion method (such as being included in the HTML file for the webpage, being in an IFrame in the HTML file, or being rendered by execution of a script); presentation mode (such as inline, pop-up, pop-under, pre-roll, etc.); destination landing page URL; ad server (such as DOUBLECLICK DART for ADVERTISERS or GOOGLE ADWORDS); expected click-through rate (eCTR); an ad quality score; one or more targeted keywords and/or one or more targeted publishers; and advertiser. Online advertising campaigns (which may encompass multiple advertisements at multiple publishers) may have similar attributes. As described above, particular embodiments collect information about advertisements, such as their attributes, for use by advertisers in the planning and management of their online advertising. Particular embodiments similarly collect information about online advertising campaigns. Particular embodiments may store the collected information in one or more data storages 1440.

In particular embodiments, an ad exchange 1404 (such as, for example ad exchange 110 as illustrated in FIG. 1) may reside or be implemented on one or more servers (e.g., exchange servers). Ad exchange 1404 may be implemented as hardware, software, or embedded logic components or a combination of two or more such components and capable of carrying out the appropriate functionalities such as buying and selling ad inventories, managing bids or advertising orders, etc.

In particular embodiments, a advertising platform may reside or be implemented on one or more servers (e.g., application servers) and may be operated by a broker (e.g., broker 1140 as illustrated in FIG. 1) on behalf of or representing one or more advertisers (e.g., advertisers 150 as illustrated in FIG. 1) or by an advertiser (e.g., advertisers 150 as illustrated in FIG. 1). Advertising platform 1402 may be implemented as hardware, software, or embedded logic components or a combination of two or more such components and capable of carrying out the appropriate functionalities such as selecting ad inventories, determining bidding amounts, constructing customized advertisements and landing pages for individual visitors, analyzing visitor responses, etc.

FIG. 15 illustrates an example computer system 1500. In particular embodiments, one or more computer systems 1500 perform one or more steps of one or more methods described or illustrated herein. In particular embodiments, one or more computer systems 1500 provide functionality described or illustrated herein. In particular embodiments, software running on one or more computer systems 1500 performs one or more steps of one or more methods described or illustrated herein or provides functionality described or illustrated herein. Particular embodiments include one or more portions of one or more computer systems 1500. Herein, reference to a computer system may encompass a computing device, and vice versa, where appropriate. Moreover, reference to a computer system may encompass one or more computer systems, where appropriate.

This disclosure contemplates any suitable number of computer systems 1500. This disclosure contemplates computer system 1500 taking any suitable physical form. As example and not by way of limitation, computer system 1500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1500 may include one or more computer systems 1500; be unitary or distributed; span multiple locations; span multiple machines; span multiple data centers; or reside in a cloud, which may include one or more cloud components in one or more networks. Where appropriate, one or more computer systems 1500 may perform without substantial spatial or temporal limitation one or more steps of one or more methods described or illustrated herein. As an example and not by way of limitation, one or more computer systems 1500 may perform in real time or in batch mode one or more steps of one or more methods described or illustrated herein. One or more computer systems 1500 may perform at different times or at different locations one or more steps of one or more methods described or illustrated herein, where appropriate.

In particular embodiments, computer system 1500 includes a processor 1502, memory 1504, storage 1506, an input/output (I/O) interface 1508, a communication interface 1510, and a bus 1512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1502 includes hardware for executing instructions, such as those making up a computer program. As an example and not by way of limitation, to execute instructions, processor 1502 may retrieve (or fetch) the instructions from an internal register, an internal cache, memory 1504, or storage 1506; decode and execute them; and then write one or more results to an internal register, an internal cache, memory 1504, or storage 1506. In particular embodiments, processor 1502 may include one or more internal caches for data, instructions, or addresses. This disclosure contemplates processor 1502 including any suitable number of any suitable internal caches, where appropriate. As an example and not by way of limitation, processor 1502 may include one or more instruction caches, one or more data caches, and one or more translation lookaside buffers (TLBs). Instructions in the instruction caches may be copies of instructions in memory 1504 or storage 1506, and the instruction caches may speed up retrieval of those instructions by processor 1502. Data in the data caches may be copies of data in memory 1504 or storage 1506 for instructions executing at processor 1502 to operate on; the results of previous instructions executed at processor 1502 for access by subsequent instructions executing at processor 1502 or for writing to memory 1504 or storage 1506; or other suitable data. The data caches may speed up read or write operations by processor 1502. The TLBs may speed up virtual-address translation for processor 1502. In particular embodiments, processor 1502 may include one or more internal registers for data, instructions, or addresses. This disclosure contemplates processor 1502 including any suitable number of any suitable internal registers, where appropriate. Where appropriate, processor 1502 may include one or more arithmetic logic units (ALUs); be a multi-core processor; or include one or more processors 1502. Although this disclosure describes and illustrates a particular processor, this disclosure contemplates any suitable processor.

In particular embodiments, memory 1504 includes main memory for storing instructions for processor 1502 to execute or data for processor 1502 to operate on. As an example and not by way of limitation, computer system 1500 may load instructions from storage 1506 or another source (such as, for example, another computer system 1500) to memory 1504. Processor 1502 may then load the instructions from memory 1504 to an internal register or internal cache. To execute the instructions, processor 1502 may retrieve the instructions from the internal register or internal cache and decode them. During or after execution of the instructions, processor 1502 may write one or more results (which may be intermediate or final results) to the internal register or internal cache. Processor 1502 may then write one or more of those results to memory 1504. In particular embodiments, processor 1502 executes only instructions in one or more internal registers or internal caches or in memory 1504 (as opposed to storage 1506 or elsewhere) and operates only on data in one or more internal registers or internal caches or in memory 1504 (as opposed to storage 1506 or elsewhere). One or more memory buses (which may each include an address bus and a data bus) may couple processor 1502 to memory 1504. Bus 1512 may include one or more memory buses, as described below. In particular embodiments, one or more memory management units (MMUs) reside between processor 1502 and memory 1504 and facilitate accesses to memory 1504 requested by processor 1502. In particular embodiments, memory 1504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1504 may include one or more memories 1504, where appropriate. Although this disclosure describes and illustrates particular memory, this disclosure contemplates any suitable memory.

In particular embodiments, storage 1506 includes mass storage for data or instructions. As an example and not by way of limitation, storage 1506 may include a hard disk drive (HDD), a floppy disk drive, flash memory, an optical disc, a magneto-optical disc, magnetic tape, or a Universal Serial Bus (USB) drive or a combination of two or more of these. Storage 1506 may include removable or non-removable (or fixed) media, where appropriate. Storage 1506 may be internal or external to computer system 1500, where appropriate. In particular embodiments, storage 1506 is non-volatile, solid-state memory. In particular embodiments, storage 1506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1506 taking any suitable physical form. Storage 1506 may include one or more storage control units facilitating communication between processor 1502 and storage 1506, where appropriate. Where appropriate, storage 1506 may include one or more storages 1506. Although this disclosure describes and illustrates particular storage, this disclosure contemplates any suitable storage.

In particular embodiments, I/O interface 1508 includes hardware, software, or both, providing one or more interfaces for communication between computer system 1500 and one or more I/O devices. Computer system 1500 may include one or more of these I/O devices, where appropriate. One or more of these I/O devices may enable communication between a person and computer system 1500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1508 for them. Where appropriate, I/O interface 1508 may include one or more device or software drivers enabling processor 1502 to drive one or more of these I/O devices. I/O interface 1508 may include one or more I/O interfaces 1508, where appropriate. Although this disclosure describes and illustrates a particular I/O interface, this disclosure contemplates any suitable I/O interface.

In particular embodiments, communication interface 1510 includes hardware, software, or both providing one or more interfaces for communication (such as, for example, packet-based communication) between computer system 1500 and one or more other computer systems 1500 or one or more networks. As an example and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1510 for it. As an example and not by way of limitation, computer system 1500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1500 may include any suitable communication interface 1510 for any of these networks, where appropriate. Communication interface 1510 may include one or more communication interfaces 1510, where appropriate. Although this disclosure describes and illustrates a particular communication interface, this disclosure contemplates any suitable communication interface.

In particular embodiments, bus 1512 includes hardware, software, or both coupling components of computer system 1500 to each other. As an example and not by way of limitation, bus 1512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1512 may include one or more buses 1512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a computing device, accessing information comprising at least a portion of a product catalog of an advertiser;
by a computing device, accessing a graph comprising a plurality of nodes and a plurality of edges connecting the nodes, each node connected by at least one edge to at least one other node in the graph, each node representing a concept related to at least one vertical, each edge representing a relationship between two nodes, at least a first node associated with at least one second node based on a relationship between a meaning of the concept represented by the first node and a meaning of the concept represented by the second node, at least a portion of the graph corresponding to the portion of the product catalog of the advertiser;
by a computing device, enriching information associated with the portion of the product catalog with information related to the concepts and relationships represented by the portion of the graph corresponding to the portion of the product catalog of the advertiser.
